(19) United States
(12) Patent Application Publication
(10) Pub. No.: US 2025/0337537 A1
(43) Pub. Date: Oct. 30, 2025

(54) METHODS, DEVICES AND COMPUTER STORAGE MEDIA FOR COMMUNICATION

(71) Applicant: NEC CORPORATION, Tokyo (JP)

(72) Inventors: Peng GUAN, Beijing (CN); Yukai GAO, Beijing (CN); Gang WANG, Beijing (CN)

(73) Assignee: NEC CORPORATION, Tokyo (JP)

(21) Appl. No.: 18/724,966

(22) PCT Filed: Dec. 28, 2021
(86) PCT No.: PCT/CN2021/142208

§ 371 Date: Jun. 28, 2024

(51) Int. Cl. H04L 5/00; H04L 27/26

(52) U.S. Cl. CPC H04L 5/0044; H04L 27/261

(57) ABSTRACT

Embodiments of the present disclosure relate to a method, device and computer readable storage medium of communication. The method comprises receiving at least one DCI message, the at least one DCI message indicating at least one of the following: a first TCI indication, a second TCI indication, or a third TCI indication; determining at least one TCI state based on the at least one DCI message; and performing a transmission with a network based on the at least one TCI state. In this way, multiple TCI states may be indicated for a multi-TRP transmission.

### FIELD

Embodiments of the present disclosure generally relate to the field of telecommunication, and in particular, to methods, devices and computer storage media for communication.

### BACKGROUND

Technology of multiple input multiple output (MIMO) has been widely used in current wireless communication system, where a large number of antenna elements are used by a network device for communicating with a terminal device. Further, in order to improve the reliability and robustness of the communication between the network device and the terminal device, in release 16 of 3rd generation partnership project (3GPP), technology of multi-transmission and reception point (multi-TRP/MTRP) (as well as multi-panel reception) has been proposed and discussed for downlink data transmission (such as, physical downlink shared channel, PDSCH). In release 17, the multi-TRP transmission is enhanced for other physical channels (such as, physical downlink control channel, PDCCH, physical uplink shared channel, PUSCH, and physical uplink control channel, PUCCH), based on release 15/16 of 3GPP unified transmission configuration indicator (TCI)/spatial relation framework. Meanwhile, in release 17, unified TCI framework is developed to replace/supplement release 15/16 TCI/spatial relation framework for beam indication.

Generally speaking, a downlink control information (DCI) message may be used by the network device to indicate the scheduling information to the terminal device. Although some proposals about the DCI message for enabling multi-TRP and/or multi-panel have been discussed and some agreements have been reached, it is still desirable to enhance the structure of the DCI, such that the multi-TRP transmission may be better supported.

### SUMMARY

In general, example embodiments of the present disclosure provide methods, devices and computer storage media for communication.

In a first aspect, there is provided a method of communication. The method comprises: receiving, at a terminal device, at least one DCI message, the at least one DCI message indicating at least one of the following: a first TCI indication associated with a first control resource set pool, a second TCI indication associated with a second control resource set pool, or a third TCI indication associated with either or both of the first and second control resource set pools; determining at least one TCI state based on the at least one DCI message, the at least one TCI state comprising at least one of the following: a first TCI state to be applied to the first control resource set pool, or a second TCI state to be applied to the second control resource set pool; and performing, based on the at least one TCI state, a transmission with a network.

In a second aspect, there is provided a method of communication. The method comprises: receiving, at a terminal device, at least one DCI message indicating at least one TCI state to be applied by the terminal device; and performing a PUSCH transmission by at least one of the following: performing the PUSCH transmission based on precoding information determined by a latest sounding reference signal (SRS) transmission transmitted with the at least one indicated TCI states; or applying the at least one indicated TCI state to the PUSCH transmission if the latest SRS transmission is transmitted based on the at least one indicated TCI state.

In a third aspect, there is provided a method of communication. The method comprises: detecting, at a terminal device, a beam failure; and if there is an available uplink TCI state, transmitting a beam failure recovery request to a network with the available uplink TCI state.

In a fourth aspect, there is provided a method of communication. The method comprises: transmitting, at a network device, at least one DCI message, the at least one DCI message indicating at least one of the following: a first TCI indication associated with a first control resource set pool, a second TCI indication associated with a second control resource set pool, or a third TCI indication associated with either or both of the first and second control resource set pools; determining at least one TCI state based on the at least one DCI message, the at least one TCI state comprising at least one of the following: a first TCI state to be applied to the first control resource set pool, or a second TCI state to be applied to the second control resource set pool; and performing, based on the at least one TCI state, a transmission with a terminal device.

In a fifth aspect, there is provided a method of communication. The method comprises: transmitting, at a network device, at least one DCI message indicating at least one TCI state to be applied by a terminal device; and receiving a PUSCH transmission by at least one of the following: receiving the PUSCH transmission based on precoding information determined by a latest SRS transmission transmitted with the at least one indicated TCI states; or applying the at least one indicated TCI state to the PUSCH transmission if the latest SRS transmission is transmitted based on the at least one indicated TCI state.

In a sixth aspect, there is provided a method of communication. The method comprises: receiving, at a network device, a beam failure recovery request transmitted by a terminal device with the available uplink TCI state; and transmitting, to the terminal device, a response of the beam failure recovery request.

In a seventh aspect, there is provided a terminal device. The terminal device comprises circuitry configured to perform the method according to the above first aspect of the present disclosure.

In an eighth aspect, there is provided terminal device. The terminal device comprises circuitry configured to perform the method according to the above second aspect of the present disclosure.

In a ninth aspect, there is provided terminal device. The terminal device comprises circuitry configured to perform the method according to the above third aspect of the present disclosure.

In a tenth aspect, there is provided network device. The network device comprises circuitry configured to perform the method according to the above fourth aspect of the present disclosure.

In an eleventh aspect, there is provided network device. The network device comprises circuitry configured to perform the method according to the above fifth aspect of the present disclosure.

In a twelfth aspect, there is provided network device. The network device comprises circuitry configured to perform the method according to the above sixth aspect of the present disclosure.

In a thirteenth aspect, there is provided a computer readable medium having instructions stored thereon. The instructions, when executed on at least one processor, causing the at least one processor to perform the method according to any of the above first to fourth aspects of the present disclosure.

It is to be understood that the summary section is not intended to identify key or essential features of embodiments of the present disclosure, nor is it intended to be used to limit the scope of the present disclosure. Other features of the present disclosure will become easily comprehensible through the following description.

### BRIEF DESCRIPTION OF THE DRAWINGS

Through the more detailed description of some embodiments of the present disclosure in the accompanying drawings, the above and other objects, features and advantages of the present disclosure will become more apparent, wherein:

FIGS. 1A to 1C illustrate example communication networks in which embodiments of the present disclosure can be implemented;

FIG. 2 illustrates an example of multi-TRP transmission with the above four transmission schemes

FIGS. 3A to 3D illustrate signaling flows for communication according to some example embodiments of the present disclosure;

FIG. 4 illustrates an example applying timing for the multi-DCI;

FIG. 5 illustrates an example applying timing for the multi-DCI;

FIG. 6 illustrates a flowchart of an example method performed by a terminal device in accordance with some embodiments of the present disclosure;

FIG. 7 illustrates a flowchart of an example method performed by a terminal device in accordance with some embodiments of the present disclosure;

FIG. 8 illustrates a flowchart of an example method performed by a terminal device in accordance with some embodiments of the present disclosure;

FIG. 9 illustrates a flowchart of an example method performed by a network device in accordance with some embodiments of the present disclosure;

FIG. 10 illustrates a flowchart of an example method performed by a network device in accordance with some embodiments of the present disclosure;

FIG. 11 illustrates a flowchart of an example method performed by a network device in accordance with some embodiments of the present disclosure; and

FIG. 12 is a simplified block diagram of a device that is suitable for implementing embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. Embodiments described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

In some examples, values, procedures, or apparatus are referred to as “best,” “lowest,” “highest,” “minimum,” “maximum,” or the like. It will be appreciated that such descriptions are intended to indicate that a selection among many used functional alternatives can be made, and such selections need not be better, smaller, higher, or otherwise preferable to other selections.

As used herein, the term “network device” refers to a device which is capable of providing or hosting a cell or coverage where terminal devices can communicate. Examples of a network device include, but not limited to, a Node B (NodeB or NB), an Evolved NodeB (eNodeB or eNB), a NodeB in new radio access (gNB) a Remote Radio Unit (RRU), a radio head (RH), a remote radio head (RRH), a low power node such as a femto node, a pico node, a statellite network device, an aircraft network device, and the like. For the purpose of discussion, in the following, some example embodiments will be described with reference to eNB as examples of the network device.

As used herein, the term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VOIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. In the following description, the terms “terminal device”, “communication device”, “terminal”, “user equipment” and “UE” may be used interchangeably.

As used herein, the term “communication network” refers to a network following any suitable communication standards, such as New Radio (NR), Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the fifth generation (5G) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “core device” refers to any device or entity that provides access and mobility management function (AMF), session management function (SMF), user plane function (UPF), etc. By way of example rather than limitation, the core device may be an AMF, a SMF, a UPF, etc. In other embodiments, the core device may be any other suitable device or entity.

As used herein, the term “end marker” refers to one message between the two ends/devices/elements of the user plane of the interfaces, such as, Iu, Gn, Gp, S1-U, S11-U, S2a, S2b, S4, S5, S8, S12, X2, MI, Sn, Xn, N3 and N9. By way of example rather than limitation, the end marker may be a GPRS Tunnel Protocol-user plane (GPT-U) end marker.

As used herein, the terms “UL transmission”, “SDT” and “UL data” are equivalent with each other.

The term “circuitry” used herein may refer to hardware circuits and/or combinations of hardware circuits and software. For example, the circuitry may be a combination of analog and/or digital hardware circuits with software/firmware. As a further example, the circuitry may be any portions of hardware processors with software including digital signal processor(s), software, and memory(ies) that work together to cause an apparatus, such as a terminal device or a network device, to perform various functions. In a still further example, the circuitry may be hardware circuits and or processors, such as a microprocessor or a portion of a microprocessor, that requires software/firmware for operation, but the software may not be present when it is not needed for operation. As used herein, the term circuitry also covers an implementation of merely a hardware circuit or processor(s) or a portion of a hardware circuit or processor(s) and its (or their) accompanying software and/or firmware.

Although functionalities described herein can be performed, in various example embodiments, in a fixed and/or a wireless network node may, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

A wireless communication network comprises at least one network device and at least one terminal device. Further, the network device and the terminal device may communicate with each other via uplink (such as, PUSCH and PUCCH) or downlink transmission (such as, PDSCH and PDCCH). Further, the network device may configure/indicate the resources for performing the uplink and downlink transmission.

In order to improve the reliability and robustness, the network device and the terminal device communicate with each other via different beams to enable a directional communication. In the related solution, for the target channel/signal, the terminal device should assume same transmit/receive beam as for reference signal. Therefore, information containing reference signal index is the beam indication.

As discussed previously, in the release 16 of 3GPP, the technology of multi-TRP has been proposed and discussed mainly for downlink data transmission (such as, physical downlink shared channel, PDSCH). Further, it is agreed that different channels/signals are configured by different TCI indication schemes. Specifically, different signalling combinations may be used for configuring/activating different channel transmissions. In other words, each channel transmission requires a separate configuration/activation, which increases the signalling overhead.

In release 17, enhancements on the support for multi-TRP deployment have been discussed. For example, it has been proposed to identify and specify features to improve reliability and robustness for physical channels (such as, PDCCH, PUSCH, PUCCH) other than Physical Downlink Shared Channel (PDSCH) using multi-TRP and/or multi-panel, based on release 15/16 of 3GPP TCI/spatial relation framework. In addition, a concept of unified TCI has been introduced. By using the unified TCI, downlink/uplink channels/signals may share a same indicated TCI state. In this way, the signalling overhead has been decreased.

Although the concept of unified TCI framework has been introduced, there are still details needed to be further discussed because the actual communication environment for the multi-TRP is relatively complicated.

According to some of the embodiments of the present disclosure, procedures for configuring/activating beam/TCI state/channel resource and procedures for beam failure recovery may be improved.

In some embodiments, some signals/channels may be grouped into different combinations, such that different signals/channels in a same combination may be processed by same transmission parameters. Some exemplary combinations are listed as below:
Combination #1: used for a regular UE-specific downlink scheduling, including channels PDCCH, PDSCH and PUCCH, where the PDCCH schedules PDSCH and the PUCCH carries feedback information (such as, hybrid automatic repeat request-acknowledgement, HARQ-ACK) for the PDSCH;
Combination #2: used for a regular UE-specific unlink scheduling, including PDCCH and PUSCH, where the PDCCH schedules PUSCH;
Combination #3: used for a ACK procedure for the DCI-based beam indication, inducing PDCCH and PUCCH, where the PDCCH indicates beam information without downlink/uplink assignment and the PUCCH carries HARQ-ACK for beam indication;
Combination #4: used for configuring RS, including PDCCH and the RSS
Combination #5: including PDCCH and signalling other functions, such as, transmit power control (TPC) for PUCCH/SRS and so on.

It is to be understood that the above combination are only for the purpose of illustration without suggesting any limitations. In some other example embodiments, the signals/channels may be grouped into any suitable combination. The present disclosure is not limited in this regard.

In this present disclosure, some terms may refer to same or similar physical meaning and may be used interchangeably. Some exemplary examples are listed as below.
The terms “control resource set pool”, “control resource set”, “CORESET”, “CORESET pool”, “TRP”, “TCI state” and “TCI” can be used interchangeably;
The terms “control resource set pool identity/index”, “control resource set identity/index”, “CORESET identity/index”, “CORESET pool identity/index”, “TRP identity/index”, “TCI state identity/index” and “TCI identity/index” can be used interchangeably;
The terms “RS”, “RS resource” can be used interchangeably;
The terms “indicated TCI state”, “new TCI state” and “TCI state to be applied” can be used interchangeably;
The terms “old TCI state”, “previously indicated TCI state”, “active TCI state”, “activated TCI state”, “applied TCI state” “currently-applied TCI state” and “current TCI state” can be used interchangeably;
The terms “beam failure”, “link failure” and “radio link failure” can be used interchangeably;
The terms “precoder”, “precoding”, “precoding matrix”, “beam”, “spatial relation information”, “spatial relation info”, “TPMI”, “precoding information”, “precoding information and number of layers”, “precoding matrix indicator (PMI)”, “precoding matrix indicator”, “transmission precoding matrix indication”, “precoding matrix indication”, “TCI state”, “transmission configuration indicator”, “quasi co-location (QCL)”, “quasi-co-location”, “QCL parameter”, “QCL assumption”, “QCL relationship” and “spatial relation” can be used interchangeably;
The terms “single TRP”, “single TCI state”, “single TCI”, “S-TCI”, “single CORESET”, “single control resource set pool”, “S-TRP” and “S-TCI state” can be used interchangeably;
The terms “multiple TRPs”, “multiple TCI states”, “multiple CORESETs” and “multiple control resource set pools”, “multi-TRP”, “multi-TCI state”, “multi-TCI”, “multi-CORESET” and “multi-control resource set pool”, “MTRP” and “M-TCI”, “M-TPR” can be used interchangeably.

As used herein, the term “TRP” refers to an antenna array (with one or more antenna elements) available to the network device located at a specific geographical location. Although some embodiments of the present disclosure are described with reference to a scenario of multi-TRPs (or a scenario of single TRP) for example, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

As used herein, term “SRS transmission” refers to a transmission of SRS resource identified by SRS signal resource indicator (SRI) in a DCI message for uplink grant. Accordingly, term “the latest SRS transmission” refers to the latest transmission of SRS resource identified by SRI in a DCI message for uplink grant.

As used herein, term “network”/“network device(s)” refer to one or more network devices. Accordingly, terms “network”, “network device(s)” and “one or more network devices” can be used interchangeably.

### Example Environment

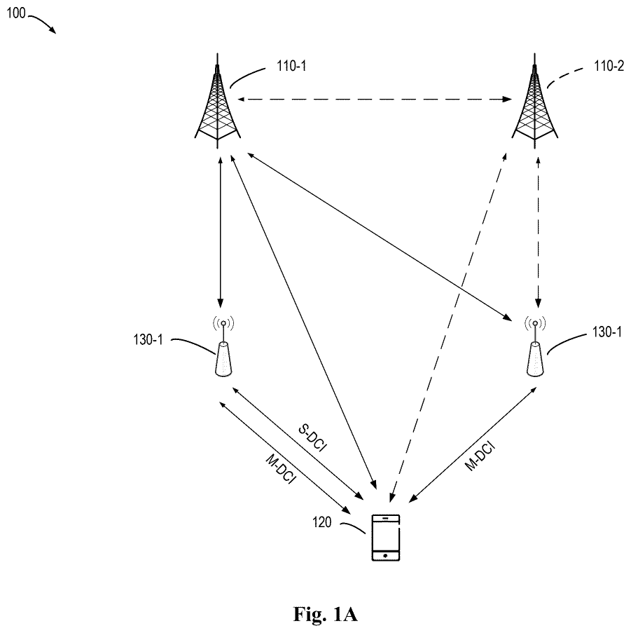

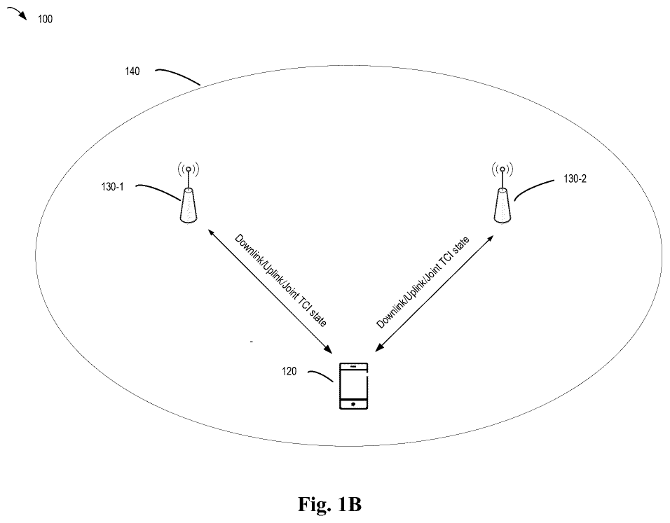

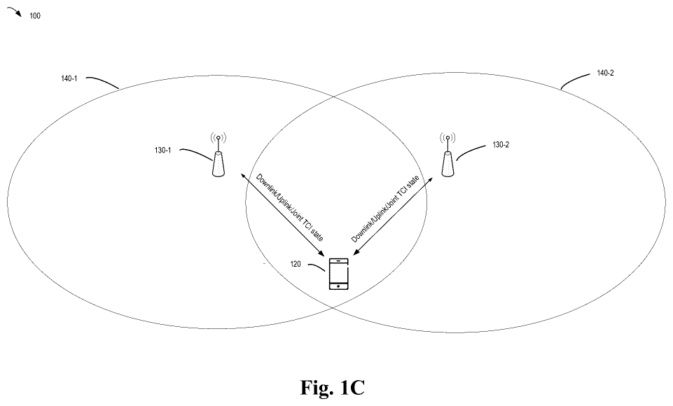

FIG. 1A illustrates an example communication network 100 (also referred to as “network” for brevity sometimes) in which embodiments of the present disclosure can be implemented. The communication network 100 includes a network device 110-1 and an optionally network device 110-2 (collectively or individually referred to as network devices 110). The network device 110 can provide services to a terminal device 120. For purpose of discussion, the network device 110-1 is referred to as the first network device 110-1, and the network device 110-2 is referred to as the second network device 110-2. Further, the first network device 101-1 and the second network device 110-1 can communicate with each other.

In the environment 100, a link from the network devices 110 (such as, a first network device 110-1 or the second network device 110-2) to the terminal device 120 is referred to as a downlink, while a link from the terminal device 120 to the network devices 110 (such as, a first network device 110-1 or the second network device 110-2) is referred to as an uplink. In downlink, the first network device 110-1 or the second network device 120-1 is a transmitting (TX) device (or a transmitter) and the terminal device 120 is a receiving (RX) device (or a receiver). In uplink, the terminal device 120 is a transmitting TX device (or a transmitter) and the first network device 110-1 or the second network device 110-2 is a RX device (or a receiver).

In some embodiments, the network device(s) 110 and the terminal device 120 may communicate with direct links/channels.

Further, in the specific example of FIG. 1A, a multi-TRP transmission also is supported. As illustrated in FIG. 1A, the terminal device 120 may communicate with two TRPs, i.e., the TRPs 130-1 and 130-2 (collectively or individually referred to as TRP 130). For purpose of discussion, the TRP 130-1 is referred to as the first TRP 130-1, and the TRP 130-2 is referred to as the second TRP 130-2.

In addition, in order to support multi-TRP and/or multi-panel, the network device 110 may be equipped with one or more TRPs. For example, the network device 110 may be coupled with multiple TRPs in different geographical locations to achieve better coverage. In one specific example embodiment, the first network device 110-1 is equipped with the first TRP 130-1 and the second TRP 130-2. Alternatively, in another specific example embodiment, the first network device 110-1 and the second network device 110-2 are equipped with the first TRP 130-1 and the second 130-2, respectively.

In some embodiments, the first TRP 130-1 and the second TRP 130-2 are associated with different control resource set pools (CORESET pools). For example, the first TRP 130-1 is associated with a first control resource set pool while the second TRP 130-2 is associated with a second control resource set pool.

Further, both a single TRP mode transmission and multi-TRP transmission are supported by the specific example of FIG. 1A. Specifically, in case of the single TRP mode, the terminal device 120 communicates with the network via the first TRP 130-1/second TRP 130-2, and the transmission is performed based on the first/second control resource set pool accordingly.

Alternatively, in case of the multi-TRP mode, the terminal device 120 communicates with the network via both of the first TRP 130-1 and the second TRP 130-2, and the transmission is performed based on both of the first and second control resource set pools accordingly.

Further, the network device(s) 110 may provide one or more serving cells and the first TRP 130-1 and the second TRP 130-2 may be included in a same serving cell or different serving cells. In other words, both an inter-cell transmission and an intra-cell transmission are supported by the specific example of FIG. 1A.

FIG. 1B shows an example scenario of the communication network 100 as shown in FIG. 1A. In the specific example of FIG. 1B, the first TRP 130-1 and the second TRP 130-2 are included in a same serving cell 140. In this event, the multi-TRP transmission is performed as an intra-cell transmission.

FIG. 1C shows another example scenario of the communication network 100 as shown in FIG. 1A. In the specific example of FIG. 1C, the first TRP 130-1 and the second TRP 130-2 are included in different serving cells 140-1 and 140-2. In this event, the multi-TRP transmission is performed as an inter-cell transmission.

Further, the unified TCI framework is supported in the communication network 100. In some embodiments, the network device 110 may pre-configure a plurality of TCI states for the terminal device 120 via such as a RRC signalling. Next, the multi-TRP/single TRP transmission may be scheduled by either a single DCI message or multiple DCI message (i.e., multi-DCI/M-DCI). Specifically, one or more pre-configured TCI states may be indicated by the single/multiple DCI messages.

As illustrated in FIG. 1A, when a single DCI mode is applied, the terminal device 120 receives a single DCI message from the first TRP 130-1. It should be understood that the single DCI message also may be received from the second TRP 130-2.

Alternatively, when a multi-DCI mode is applied, the terminal device 120 receives two DCI messages from the first TRP 130-1 and the second TRP 130-2, respectively.

By applying the indicated TCI states, the first TRP 130-1 and the second TRP 130-2 may be selectable activated and a directional transmission is achieved.

In some embodiments, the indicated TCI states may be any of below:
Joint downlink/uplink TCI state (i.e., joint DL/UL TCI state): refers to at least a common source reference RS used for determining both the downlink QCL information and the uplink TX spatial filter.
Separate downlink/uplink TCI (i.e., separate DL/UL TCI state): the downlink TCIs and uplink TCIs are distinct.

In this way, the terminal device 120 may be configured with M downlink TCI states and N uplink TCI states, where M>=0 and N>=0.

In some embodiments, the source RS(s) in M downlink TCI states provide common QCL information at least for UE-dedicated reception on PDSCH and all or subset of CORESETs in a component carrier (CC). In addition, the source RS(s) in M downlink TCI states provide common QCL information for non-UE-dedicated reception on PDSCH and all or subset of non-UE-dedicated CORESETs in a CC.

In some embodiments, each of the M source reference signals (or 2M, if qcl_Type2 is configured in addition to qcl_Type1) in the M downlink TCIs provides QCL information at least for one of the M beam pair links for UE-dedicated receptions on PDSCH and/or subset of CORESETs in a CC. In addition, each of the M source reference signals (or 2M, if qcl_Type2 is configured in addition to qcl_Type1) in the M downlink TCIs provides common QCL information for non-UE-dedicated reception on PDSCH and all or subset of non-UE-dedicated CORESETs in a CC.

In some embodiments, the source reference signal(s) in N uplink TCI states provide a reference for determining common uplink TX spatial filter(s) at least for dynamic-grant/configured-grant based PUSCH, all or subset of dedicated PUCCH resources in a CC. Optionally, the uplink TX spatial filter can also apply to all SRS resources in resource set(s) configured for antenna switching, codebook-based (CB) uplink transmissions or non-CB (NCB) uplink transmissions.

In some embodiments, each of the N source reference signals in the N uplink TCI states provide a reference for determining uplink TX spatial filter at least for one of the N beam pair links associated with dynamic-grant(s)/configured-grant(s) based PUSCH, and/or subset of dedicated PUCCH resources in a CC.

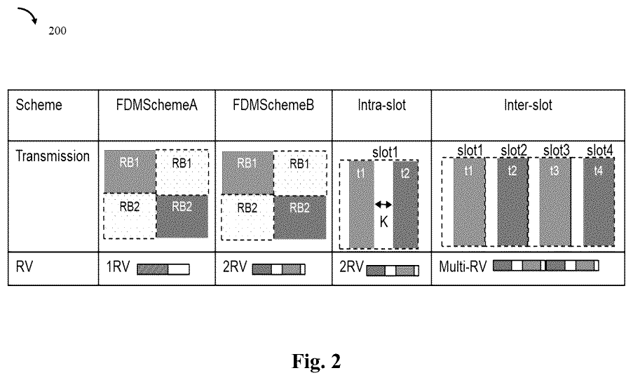

Further, different transmission schemes are supported and used for improving the reliability for the downlink transmission, such as, frequency division multiple scheme A (FDMSchemeA), FDM scheme B (FDMSchemeB), time division multiple scheme A (TDMSchemeA, intra-slot) and inter-slot based TDM scheme. FIG. 2 illustrates an example of multi-TRP transmission 200 with the above four transmission schemes. As can be seen from FIG. 2, based on the different transmission schemes, each transmission may be associated with a same or different redundancy version (RV).

The communications in the communication environment 100 may conform to any suitable standards including, but not limited to, Long Term Evolution (LTE), LTE-Evolution, LTE-Advanced (LTE-A), Wideband Code Division Multiple Access (WCDMA), Code Division Multiple Access (CDMA) and Global System for Mobile Communications (GSM) and the like. Furthermore, the communications may be performed according to any generation communication protocols either currently known or to be developed in the future. Examples of the communication protocols include, but not limited to, the first generation (1G), the second generation (2G), 2.5G, 2.75G, the third generation (3G), the fourth generation (4G), 4.5G, the fifth generation (5G), 5.5G, 5G-Advanced networks, or the sixth generation (6G) communication protocols.

It is to be understood that the numbers of devices (i.e., the terminal device 120, the network device 110, the TRP 130 and the cell 140) and their connection relationships and types shown in FIGS. 1A to 1C are only for the purpose of illustration without suggesting any limitation. The communication network 100 may include any suitable numbers of devices adapted for implementing embodiments of the present disclosure.

### EXAMPLE PROCESSES

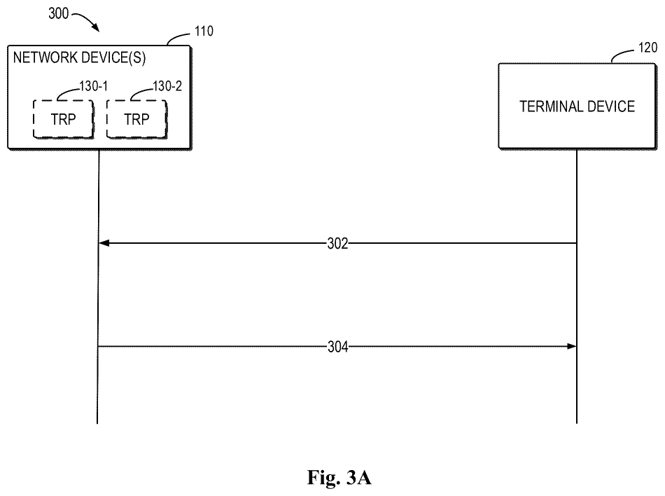

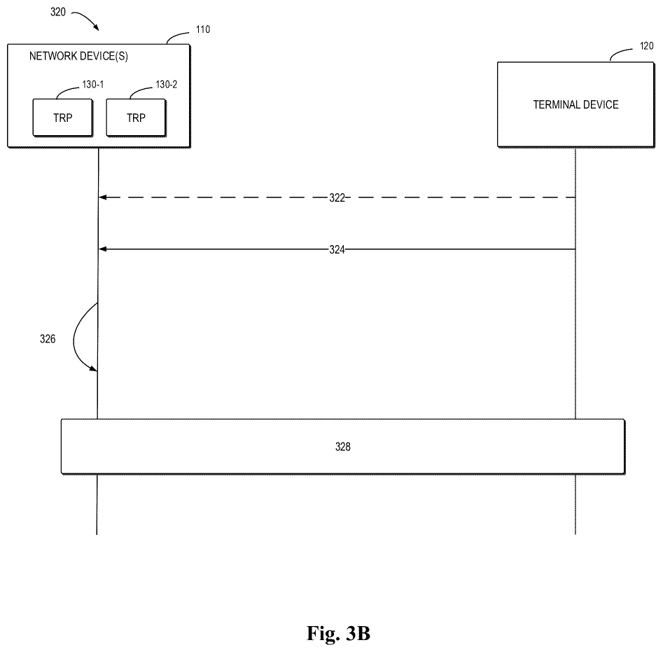

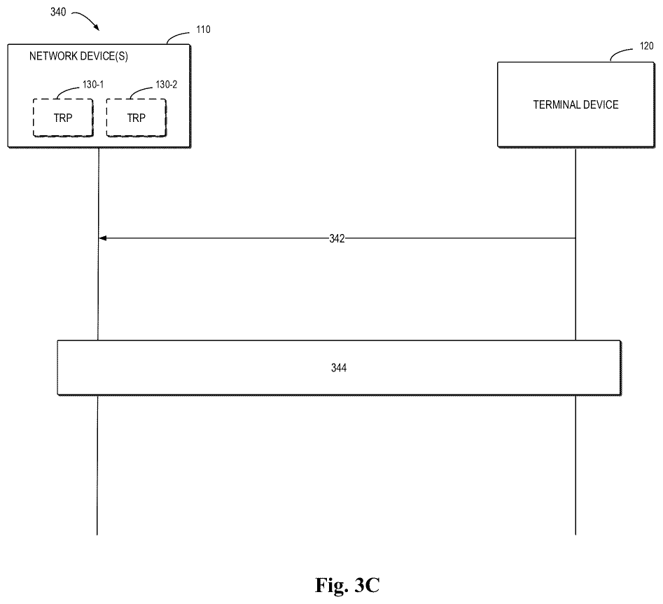

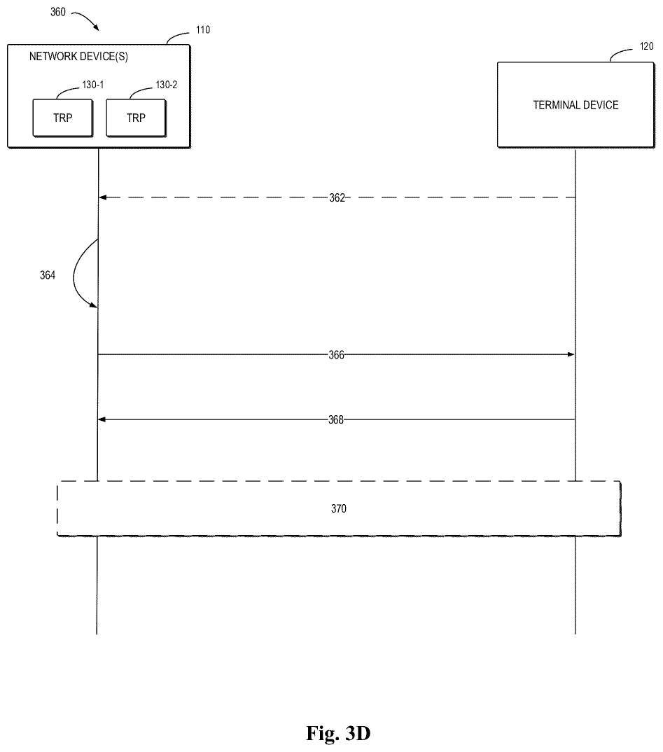

Principle and implementations of the present disclosure will be described in detail below with reference to FIGS. 3A to 3D, which show signaling charts illustrating processes 300, 320, 340 and 360 of communication according to some example embodiments of the present disclosure. For the purpose of discussion, the processes 300, 320, 340 and 360 will be described with reference to FIGS. 1A to 1C.

The processes 300, 320, 340 and 360 may involve the terminal device 120, the network device 110 (either or both of the first network device 110-1 or the second network device 110-2), and optionally may involve the TRPs 130 (including the first TRP 130-1 and the second TRP 130-2). In other words, the implementations of some embodiments do not depend on the TRPs 130.

Additionally, the first TRP 130-1 is connected to the first network device 110-1, while the second TRP 130-2 is connected to the first network device 110-1/second network device 110-2. In addition, the first TRP 130-1 and the second TRP may be in a same serving cell and in different serving cells.

In the following text, although some embodiments of the present disclosure are described with reference to two TRPs, these embodiments are only for the purpose of illustration and help those skilled in the art to understand and implement the present disclosure, without suggesting any limitations as to the scope of the present disclosure. It is to be understood that the present disclosure described herein can be implemented in various manners other than the ones described below.

Further, it is to be understood that the operations at the terminal device 120 and the network device 110 should be coordinated. In other words, the network device 110 and the terminal device 120 should have common understanding about configuration, state, parameters and so on. Such common understanding may be implemented by any suitable interactions between the network device 110 and the terminal device 120 or both the network device 110 and the terminal device 120 applying the same rule/policy. In the following, although some operations are described from a perspective of the terminal device 120, it is to be understood that the corresponding operations should be performed by the network device 110. Similarly, although some operations are described from a perspective of the network device 110, it is to be understood that the corresponding operations should be performed by the terminal device 120. Merely for brevity, some of the same or similar contents are omitted here.

In addition, in the following description, some interactions are performed among the terminal device 120 and the network device 110 (such as, exchanging capability-related information, configuring/scheduling/activating resources, recovering failed beams and so on). It is to be understood that the interactions may be implemented either in one single signaling/message or multiple signaling/messages, including system information, RRC message, DCI message, uplink control information (UCI) message, media access control (MAC) control element (CE) and so on. The present disclosure is not limited in this regard.

Moreover, it should be understood that although feature(s)/operation(s) are discussed in specific example embodiments separately, unless clearly indicated to the contrary, these feature(s)/operation(s) described in different example embodiments may be used in any suitable combination.

### Example Processes for Exchanging Capability-Related Information

According to some embodiments of the present disclosure, the terminal device 120 and the network device 110 may communicate capability-related information and related configuration(s) to enable the embodiments according to the present disclosure, which will be discussed as below. During this interactive procedure, certain rules associated with the embodiments of the present disclosure may be stipulated, and the related re-defined/newly-introduced parameters may be exchanged between the terminal device 120 and the network device 110.

In addition, the capability-related information and the related configuration(s) may be carried in any suitable signalling/message(s), including but not limited to RRC message, DCI message, MAC CE and so on.

Reference is made to FIG. 3A, which illustrates signaling flow 300 for communication according to some example embodiments of the present disclosure. As illustrated in FIG. 3A, the terminal device 120 transmits 302 the capability-related information to the network device 110.

Some examples of the capability-related information are listed as below:
whether the S-DCI mode is supported by the terminal device 120,
whether the multi-DCI mode is supported by the terminal device 120,
whether the S-TCI mode is supported by the terminal device 120,
whether the multi-TCI mode is supported by the terminal device 120,
a maximum number of TCI states supported by the terminal device 120,
a maximum number of joint TCI states supported by the terminal device 120,
a maximum number of uplink TCI states supported by the terminal device 120,
a maximum number of downlink TCI states supported by the terminal device 120,
a maximum number of TRPs supported by the terminal device 120,
whether the terminal device 120 supports to be configured with unified TCI states, joint DL/UL TCI states, and/or separated DL/UL TCI states for multi-TRP,
whether the terminal device 120 supports to be configured with an additional downlink TCI state and/or an additional uplink TCI state in addition to a joint TCI state,
whether the terminal device 120 supports to be configured with more uplink TCI states compared with downlink TCI states,
whether the terminal device 120 supports to be configured with more downlink TCI states compared with uplink TCI states,
capability about the transmission schemes of multi-TCI state mode, including: coherent joint transmission (CJT), non-coherent joint transmission (NCJT), repetition, time division multiple (TDM) (inter-slot or intra-slot), frequency division multiple (FDM), spatial domain multiplexing (SDM), high speed train (HST) and so on,
whether the terminal device 120 supports a dynamic switch among a single TCI transmission and a multi-TCI state transmission,
whether the terminal device 120 supports to be pre-configured resources for the multi-TCI state transmission,
whether the terminal device 120 supports to report a beam failure recovery request via an available uplink TCI state (also referred to as “extra UL TCI state” sometime),
whether the terminal device 120 supports to report a beam failure recovery request via an available uplink TCI state and a new beam identified during candidate beam detection procedure.

It is to be understood that the above illustrated capability-related information are given for illustrative purpose only. It should be understood that any suitable capability-related information associated with the embodiments discussed herein may be communicated during this stage. The present disclosure is not limited in this regard.

Still refers to FIG. 3A, the network device 110 may transmit 304 the related configuration(s) to the terminal device 120. In one example embodiment, the related configuration(s) may be generated based on the capability-related information received from the terminal device 120. In another example embodiment, the related configuration(s) is generated independently from the capability-related information.

In some embodiments, the related configuration is a higher layer configuration (via such as a RRC message) from the network device 110. In one specific example embodiments, the RRC message configures a plurality of TCI states. Below are two example parts in the RRC signalling for configuring the TCI state.

```
TCI-State-r17
  tci-StateId_r17
  tci-StateType (optional)
  qcl-Type1: QCL-Info-r17
QCL-Info-r17
  Cell
  bwp-Id
  SourceRS-Info_r17 choice of {
    NZP-CSI-RS-ResourceId
    SSB-Index
```

| | |
|---|---|
| SRS ResourceId (SRS for beam management) | - only if UL TCI |

```
    qcl-Type ENUMERATED{typeA, typeB, typeB, typeD}
    }
```

| | |
|---|---|
| pathloss RS (optional) choice of { | - if included in TCI state - for |
| | UL TCI state or Joint TCI state |

```
      SSB-Index
      NZP-CSI-RS-ResourceId (periodic CSI-RS)
      }
```

Alternatively, or in addition, the related configuration also may be used for allocating resources, enabling one or more feature/function and so on. In the following text, some related configuration(s) are discussed in specific embodiments.

It should be understood that any suitable related configuration associated with the embodiments discussed herein may be communicated during this stage. The present disclosure is not limited in this regard.

### Example Processes for Indicating the TCI States

In the scenario of multi-TRP transmission, it is needed that the DCI message(s) may indicate respective TCI state(s) for the different TRPs. According to some embodiments of the present disclosure, multiple TCI states may be indicated to the multiple TRPs.

Reference is made to FIG. 3B, which illustrates signaling flow 320 for communication according to some example embodiments of the present disclosure.

As illustrated in FIG. 3B, the terminal device 120 may receive 324 at least one DCI messages. Next, the terminal device 120 may determine 326 a first TCI state based on the at least one DCI message, where the first TCI state is to be applied to the first control resource set pool (i.e, the first TRP 130-1). Alternatively, or in addition, the terminal device 120 also may determine a second TCI state based on the at least one DCI message, where the second TCI state is to be applied to the second control resource set pool (i.e, the second TRP 130-2). Based on the determined first TCI state and/or the second TCI state, the terminal device 120 may perform 328 a transmission with a network (via either or both of the first TRP and the second TRP 130-2)

In some embodiments, the terminal device 120 performs a PUSCH transmission based on the indicated first TCI state and/or the second TCI state. Specifically, in one specific example embodiment, the terminal device 120 performs the PUSCH transmission based on precoding information determined by a latest SRS transmission transmitted with the at least one TCI states. Alternatively, in another specific example embodiment, the terminal device 120 performs a first PUSCH transmission based on first precoding information determined by a latest first SRS transmission transmitted with the indicated first TCI states. Alternatively, in a further specific example embodiment, the terminal device 120 performs a second PUSCH transmission based on second precoding information determined by a latest SRS transmission transmitted with the indicated second TCI states.

In addition, the latest SRS transmission refers to the latest transmission of SRS resource identified by SRI in DCI message for uplink grant.

In this way, the multiple TCI states may be indicated to the terminal device 120.

In the following, some exemplary embodiments about how to indicate the multiple TCI states will be discussed. More specifically, the signaling structure and signaling interaction are improved to enable indicating the multiple TCI states.

For the Single DCI mode

In some embodiments, the at least one DCI message is a single DCI message, and the single DCI message comprises a first TCI field indicating a first TCI state and a second TCI field indicating a second TCI state.

In some embodiments, the first TCI field is a bit sequence with a length of K1. Thus, the first TCI field may have 2^{K1} values which may indicate one of 2^{K1} different TCI states (or TCI state pairs, TCI state groups, TCI state combinations) to be applied for the first TPR 130-1.

In some embodiments, the second TCI field is a bit sequence with a length of K2. Thus, the second TCI field may have 2^{K2} values which may indicates one of 2^{K2} different TCI states (or TCI state pairs, TCI state groups, TCI state combinations) to be applied for the second TPR 130-2.

Additionally, prior to transmitting the single DCI message, the terminal device 120 may receive 322 more than one message (such as, MAC CE message), which establishing a mapping between all or a subset of the configured TCI state (via such as, the RRC signalling) and the TCI codepoint in the single DCI message. Specifically, the terminal device 120 receives a first MAC CE message indicating at least one first mapping and a second message indicating at least one second mapping. In particular, each first mapping indicates a first correspondence between a first TCI codepoint and a first TCI state (or TCI state pair, TCI state group, TCI state combination) while each second mapping indicates a second correspondence between a second TCI codepoint and a second TCI state (or TCI state pair, TCI state group, TCI state combination).

Optionally, in some embodiments, the TCI states indicated in the first MAC CE message is associated with/configured for the first CORESET pool while the TCI states indicated in the second MAC CE message is associated with/configured for the second CORESET. In addition, the TCI states indicated in the first MAC CE message may be different from the TCI states indicated in the second MAC CE message.

In addition, the more than one message activates all or a subset of configured TCI states which are mapped to the TCI codepoint(s). In some embodiments, the first TCI state is associated with the first TRP 130-1, and the second TCI state is associated with the second TRP 130-2. In some embodiments, the first TCI state is associated with the first CORESET pool, and the second TCI state is associated with the second CORESET pool. Below Table 1 illustrates an example of the first mapping.

TABLE 1
Example of the first mapping

| The first TCI codepoint | |
|---|---|
| (corresponding to the | Corresponding TCI state |
| first TCI field in | (e.g., associated with |
| the single DCI message) | the first TRP 130-1) |
| 0 | TCI state 1 |
| 1 | TCI state 2 |
| . . . | . . . |
| 2^{K1} | |

Below Table 2 illustrates an example of the second mapping.

TABLE 2
Example of the second mapping

| The second TCI codepoint | |
|---|---|
| (corresponding to the | Corresponding TCI state |
| second TCI field in the | (e.g., associated with |
| single DCI message) | the second TRP 130-2) |
| 0 | TCI state 1 |
| 1 | TCI state 2 |
| . . . | . . . |
| 2^{K2} | |

In this way, by reusing the current MAC CE message structure to establish the first and second mappings, the multiple TCI states may be indicated by a single DCI message.

In some embodiments, an indication used for indicating the presence of the second TCI field may be indicated by the network. In one specific example embodiment, the network device 110 transmits a RRC signalling/MAC CE message which comprises an indication of ‘secondTCIPresentInDCI’, where the indication of ‘secondTCIPresentInDCI’ is configured to indicate whether this second TCI field exists. In another specific example embodiment, the indication (such as, ‘secondTCIPresentInDCI’) is comprised in the single DCI message. In this way, the resolution operation at the terminal device 120 is simplified.

Alternatively, in case of the single DCI mode, the multiple TCI states may be indicated by a joint TCI indication (referred to as a third TCI indication), where the third TCI indication is associated with either or both of the first and second control resource set pools. Specifically, the single DCI comprising a third TCI state field indicating the third TCI indication. In this way, the multiple TCI states may be indicates by one TCI state field, which means that the current DCI structure may be reused.

Additionally, in some embodiments, the third TCI field is a bit sequence with a length of K. Thus, the third TCI field may have 2^{K} values which may indicate one of 2K different TCI states (or TCI state pairs, TCI state groups, TCI state combinations) to be applied for either or both of the first TPR 130-1 and the second TRP 130-2.

Additionally, in order to enable the interpretation of the third TCI indication at the terminal device 120, the terminal device 120 needs to receive a third MAC CE message indicating at least one third mapping, where each third mapping indicating a third correspondence between a third TCI codepoint and at least one third TCI state (or TCI state pair, TCI state group, TCI state combination), each of the at least one third TCI state (or TCI state pair, TCI state group, TCI state combination) being configured for either of the first and second control resource set pools. Below Table 3 illustrates an example of the third mapping.

| The third TCI codepoint | individual/pairs/groups of TCI |
|---|---|
| (corresponding to the | states (e.g., associated with |
| third TCI field in the | either or both of the first |
| single DCI message) | TRP 130-1 and second TRP 130-2) |
| 0 | M joint TCI states (such as, two joint |
| | TCI states for the first and second |
| | TRPs 130-1 and 130-2) |
| 1 | 1 joint TCI state + 1 DL TCI state |
| | (such as, a joint TCI states for the |
| | first TRP 130-1 and a DL TCI state |
| | for the second TRP 130-2) |
| . . . | . . . |
| 2^{K} | . . . |

In some embodiments, the third codepoints are mapped to pairs of joint TCI state, which means M=N. Alternatively, in some embodiments, the third codepoints are mapped to a group of M downlink TCI state and N uplink states. Alternatively, in some embodiments, the third codepoints are mapped to a group of L joint TCI states and (M−L) downlink TCI state and/or (N−L) uplink states. Parameter of M/N/L is a positive integer.

Additionally, some codepoints may be reserved for indicating reserved TCI state(s). In one specific example embodiment, one codepoint can be reserved to indicate ‘no TCI update’.

Additionally, in some embodiments, the bit size of the third TCI state field may be re-defined. In particular, the bit size of the third TCI state field may be defined to be larger than three, such as, 4 or 5. In this way, the third TCI state field may indicates more joint TCI states.

According to the above procedure, the first TCI state to be applied to the first control resource set pool and the second TCI state to be applied to the second control resource set pool may be determined by the terminal device 120.

In addition, the application range of the single DCI message also may be stipulated. In one specific example embodiments, the indicated TCI states (i.e., the first and the second TCI states) are applied for all the channels (including PDCCH, PDSCH, PUCCH and PUSCH).

Alternatively, the application range can be limited to a certain combination of some physical channels. Specifically, the terminal device 120 applies the first TCI state to a combination of physical channels associated with the first control resource set pool and further applies the second TCI state to a combination of physical channels associated with the second control resource set pool. Additionally, the combination of physical channel may be one of Combinations #1˜#5 as discussed previously in this disclosure.

In summary, the signaling structure and signaling interaction procedure are improved, such that the multiple TCI states may be indicated by a single DCI message.

### For the Multi-DCI Mode

As discussed previously, the multi-DCI mode is also supported by some embodiments according to the present disclosure.

In some embodiments, the at least one DCI message is multiple DCI messages. Specifically, the terminal device 120 receives a first DCI message and a second DCI message, where the first DCI message comprises a first TCI field indicating the first TCI indication and the second DCI message comprises a second TCI field indicating the second TCI indication. In some embodiments, each of the multiple DCI messages corresponds to a TRP identity (such as, the CORESETPoolIndex).

Based on the multiple DCI messages, the first TCI state to be applied to the first control resource set pool and the second TCI state to be applied to the second control resource set pool may be determined by the terminal device 120.

Different from the legacy solution where the indicated first and second TCI states are applied to all the physical channels, the application range of the indicated first and second TCI states may be limited. Specifically, the terminal device 120 applies the first TCI state to a combination of physical channels associated with the first control resource set pool and further applies the second TCI state to a combination of physical channels associated with the second control resource set pool. Additionally, the combination of physical channel may be one of Combinations #1˜#5 as discussed previously in this disclosure. In other words, the indicated TCI state of each DCI message is applied for a subset of channels, e.g., for those channels associated with the same TRP ID.

In this way, a more flexible solution for indicating the TCI states is achieved. Specifically, the application range of the multiple TCI states may be limited to a subset of the all physical channel.

According to the above procedure, the multiple TCI states may be indicated to different TRPs regardless of the single DCI mode or the multi-DCI mode.

In some embodiments, the total bit size for indicating TCI information (either in the single DCI or multi-DCI) is determine based on a plurality factors. One example factor is whether the at least one DCI messages is a single DCI or multiple DCI messages. Another example factor is a number of TCI fields comprised in at least one DCI messages. A further example factor is a number of TCI states indicated by the at least one DCI message. The other example factors may be respective bit sizes of the TCI fields.

It is to be understood that the above factors are for purpose of illustration without any limitation. In other examples, other factors may be considered when determining the total bit size for indicating TCI information. It is also to be understood that the above factors may be applied separately or in any suitable sub-combination.

### Example Processes for Applying Timing

In the related solution, after receiving the at least one DCI message, the terminal device 120 would respond an ACK for the at least one DCI message. Then the terminal device 120 may apply the TCI states indicated by the at least one DCI message after X time units offset since transmitting the ACK (i.e., right after beam application timing, BAT).

According to some embodiments of the present disclosure, a plurality of factor may be considered when applying the indicated TCI states, such that the delay of switching the TCI state may be decreased.

In some embodiments, the applying timing of the indicated TCI states is performed based on the number of TCI states indicated. Alternatively, or in addition, in some embodiments, the applying timing of the indicated TCI states is performed based on whether there is an overlapped TCI state between the indicated TCI states and the currently-applied TCI states. Alternatively, or in addition, in some embodiments, the applying timing of the indicated TCI states is performed based on whether the at least one DCI triggers a switch among a multiple TCI mode and a single TCI mode (or a switch among single TRP transmission and a multi-TRP transmission). Alternatively, or in addition, in some embodiments, the applying timing of the indicated TCI states is performed based on whether a single DCI mode or multi-DCI mode is trigged.

In the following text, some exemplary processes for the single DCI mode and the multi-DCI mode will be discussed separately.

### for the Single DCI Mode

In some embodiments, if there is an overlapped TCI state between the indicated TCI states and the currently-applied TCI states, the terminal device 120 applies the overlapped TCI state prior to applying other TCI state of the at least one TCI state.

Additionally, in some embodiments, the terminal device 120 applies the overlapped TCI state upon transmitting an ACK for the at least one DCI message to the network without waiting for X time units offset. Correspondingly, the terminal device 120 applies the other TCI state after a certain period (i.e., X time units offset) after transmitting the acknowledgement for the at least one DCI message to the network.

Alternatively, or in addition, the beam/TCI state mapping also may be determined based on whether there is an overlapped TCI state between the indicated TCI states and the currently-applied TCI states. Specifically, apply the overlapped beam first and then apply the newly-indicated TCI state. One example of the TCI state mapping pattern for the two TRP scenarios is {the overlapped TCI state, the overlapped TCI state, the newly-indicated TCI state, the newly-indicated TCI state, . . . }, if a sequential TCI state mapping is assumed. Another example of the TCI state mapping pattern for the two TRPs scenario is {the overlapped TCI state, the newly-indicated TCI state, the overlapped TCI state, the newly-indicated TCI state, . . . }, if a cyclic TCI state mapping is assumed.

In this way, by applying the overlapped TCI state first, the transmission may start earlier during the switch among TCI state(s)/beam(s).

One specific example embodiment where a single DCI triggers a switch from a single TRP transmission/single TCI mode to a multi-TRP transmission/multi-TCI mode is described first. Specifically, the terminal device 120 is operated under a single TCI state/TRP transmission mode, for example, the terminal device 120 is applying the TCI state #1. Then, the terminal device 120 receive a single DCI indicates two TCI states including the currently-applied TCI state #1 and a newly-indicated TCI state #2. In this specific example embodiment, the terminal device 120 applies the overlapped TCI state #1 first. For example, the terminal device 120 applies the overlapped TCI state #1 upon the transmitting ACK while applies the newly-indicated TCI state #2 after X time units offset since transmitting the ACK.

The procedure for the scenario of a switch from a multi-TRP transmission/multi-TCI mode to a single TRP transmission/single TCI mode is similar. Specifically, the terminal device 120 is operated under a multi TCI state/TRP transmission mode, for example the terminal device 120 is applying the TCI states #1 and #2. Then, the terminal device 120 receive a single DCI indicates the TCI state #1. In this specific example embodiment, the terminal device 120 applies the overlapped TCI state #1 first. For example, the terminal device 120 applies the overlapped TCI state #1 upon the transmitting ACK.

In a further specific example embodiment, the terminal device 120 is operated under a multi TCI state/TRP transmission mode, for example, the terminal device 120 is applying the TCI states #1 and #2. Then, the terminal device 120 receive a single DCI indicates two TCI states including the currently-applied TCI state #1 and a newly-indicated TCI state #3. In this specific example embodiment, the terminal device 120 applies the overlapped TCI state #1 first. For example, the terminal device 120 applies the overlapped TCI state #1 upon the transmitting ACK while applies the newly-indicated TCI state #3 after X time units offset since transmitting ACK.

Additionally, for this specific example embodiment, one example of the TCI state mapping pattern is {the overlapped TCI state #1, the overlapped TCI state #1, the newly-indicated TCI state #3, the newly-indicated TCI state #3}. Another example of the TCI state mapping pattern is {the overlapped TCI state #1, the newly-indicated TCI state #3, the overlapped TCI state #1, the newly-indicated TCI state #3}.

In some embodiments, when the terminal device 120 would transmit the last symbol of a PUCCH with HARQ-ACK information corresponding to the DCI carrying the TCI-State indication and the indicated TCI-State is overlapped from the previously indicated one (i.e., the currently-applied TCI-State), the indicated TCI state (such as, the indicated [TCI-State] with [tci-Stateld_r17]) should be applied starting from the first slot that is at least BeamAppTime_r17 symbols after the last symbol of the PUCCH.

### for the Multi-DCI Mode

In some embodiments according to the present discourser, the applying timings for different indicated TCI states may be determined separately. In other words, the beam application timing is determined per TRP.

In some embodiments, the at least one DCI message is multiple DCI messages, such as, the first DCI message indicating the first TCI state and the second DCI message indicating the second TCI state. The terminal device 120 applies the first TCI state and the second TCI state at a first starting point associated with the first control resource set pool and a second starting point associated with the second control resource set pool, respectively.

In some embodiments, the starting point to apply the indicated TCI state of one TRP is X time units after ACK carried by PUCCH associated with this TRP. Specifically, the terminal device 120 applies the first TCI state after X time units offset after transmitting the ACK for the first DCI message, and the terminal device 120 applies the second TCI state after X time units offset after transmitting the ACK for the second DCI message.

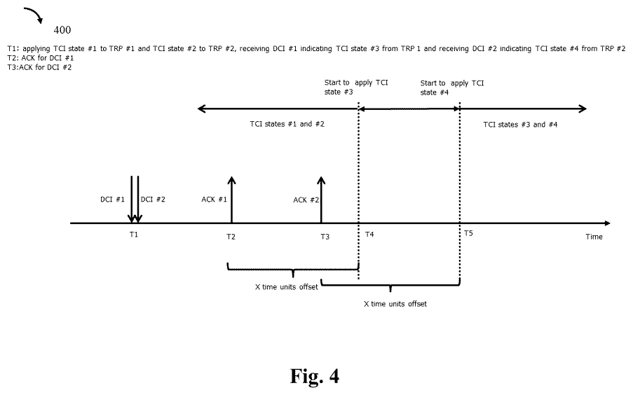

Reference is now made to FIG. 4, which illustrates an example applying timing 400 for the multi-DCI. As illustrated in FIG. 4, the terminal device 120 applies TCI state #1 to TRP #1 and TCI state #2 to TRP #2. At time point T1, the terminal device 120 receives the first DCI message indicating TCI state #3 from TRP 1 while a second DCI indicating TCI state #4 from TRP #2. Next, the terminal device 120 transmits an ACK for the first DCI message at time point T2 while the terminal device 120 transmits an ACK for the second DCI message at time point T3. After the time point T4 (X time units after T2), the newly-indicated TCI state #3 may be applied. After the time point T4 (X time units after T3), the newly-indicated TCI state #4 may be applied.

In some other embodiments, the starting point to apply the indicated TCI states of multi-TRP is X time units after multiple ACKs transmitted later in time. Specifically, if the ACK for the second DCI message is transmitted later in time than the ACK for the first DCI message, the terminal device 120 applies the first TCI state after X time units offset since transmitting the ACK for the second DCI message, and the terminal device 120 applies the second TCI state after X time units offset since transmitting the ACK for the second DCI message (i.e., both of the first and second TCI states are applied after X time units offset since transmitting the ACK for the second DCI message).

### Example Processed for Resource Allocation

According to some embodiments of the present disclosure, the resourced allocation for the multi-TRP transmission also may be improved. Specifically, the terminal device 120 may be pre-configured a plurality of transmission occasion sets, each transmission occasion set may corresponds to each TCI state (or each control resource set pool/TRP). The plurality of transmission occasion sets may be activated/deactivated according to the activation/deactivation of the corresponding TCI state(s).

In this way, no additional resource allocation procedure is needed in response to switching to the multi-TRP transmission/multi-TCI state mode.

In some embodiments, the terminal device 120 receives a configuration message from the network device 110, where the configuration message indicates at least one first transmission occasion associated with a first TCI state and at least one second transmission occasion associated with a second TCI state.

In some embodiments, the at least one first transmission occasion and the at least one second transmission occasion are associated with a specific physical channel or a specific physical channel combination (such as, one of Combinations #1˜#5 as discussed previously). The physical channels include PDSCH, PDCCH, PUSCH and PUCCH.

In some embodiments, the at least one second transmission occasion is linked to the at least one first transmission occasion by at least one pre-configuration parameter.

Specifically, as for PDCCH, the at least one first transmission occasion may be configured/indicated via a search space (SS) sets configuration, while the at least one second transmission occasion may be a linked SS sets to the PDCCH associated with the at least first transmission occasion.

As for PDSCH, the at least one first transmission occasion may be configured/indicated via a start and length indicator value (SLIV) in the DCI message, while the at least one second transmission occasion may be configured by an offset from the first transmission occasion.

As for PUCCH, the at least one first transmission occasion may be configured/indicated via an RRC signaling, while the at least one second transmission occasion may be configured by an offset (such as, a number of slots configured in RRC) from the first transmission occasion.

As for PUSCH, the at least one first transmission occasion may be configured/indicated via a SLIV in the DCI message for uplink grant, while the at least one second transmission occasion may be configured by an offset from the first transmission occasion.

In some embodiments, the at least one second transmission occasion may be configured in higher layer configuration/parameters. Further, the at least one second transmission occasion may be activated when two TCI states are indicated and may be deactivated when only one TCI state is indicated.

In some embodiments, the terminal device 120 activates the at least one first transmission occasion and the at least one second transmission occasion based on the newly-indicated TCI state(s). Alternatively, or in addition, in some embodiments, the terminal device 120 activates the at least one first transmission occasion and the at least one second transmission occasion upon a switch among a multiple TCI mode and a single TCI mode.

In some embodiments, the at least one transmission parameter associated with the at least one first transmission occasion is the same with at least second transmission parameter associated with the at least one second transmission occasion by default. In particular, in case that there are two TRPs and two joint TCI states are indicated, the at least one transmission parameter associated with the at least one first transmission occasion is the same with at least second transmission parameter associated with the at least one second transmission occasion.

One example of the at least transmission parameter is a transmission scheme. As used herein, the transmission scheme may refer to repetition scheme (at least including inter-slot TDM and intra-slot TDM), CJT, NCJT, inter-cell mobility and so on.

Another example of the at least transmission parameter is a repetition number (such as, the number of indicated TCI states).

A further example of the at least transmission parameter is a beam/TCI mapping pattern, where the beam mapping pattern is one of a cyclic mapping, a sequential mapping and a half-half mapping. In one specific example embodiment, the same beam/TCI mapping pattern is assumed if the repetition number is configured more than the number of TCI states indicated.

In some embodiments, when the repetition number is larger than a number of TCI states, the terminal device 120 may be further configured to enable cyclic mapping or sequential mapping in TCI mapping. Additionally, in some embodiments, when cyclic mapping is enabled, the first and second TCI states are applied to the first and second transmission resources, respectively, and the same TCI mapping pattern continues to the remaining transmission resources.

Additionally, in some embodiments, when sequential mapping is enabled, the first TCI state is applied to the first and second transmission resources, and the second TCI state is applied to the third and fourth transmission resources, and the same TCI mapping pattern continues to the remaining transmission resources.

Additionally, in some embodiments, the same beam/TCI state mapping pattern is conditionally applied for one or more specific channel. In one specific example embodiment, the same beam/TCI state mapping pattern is conditionally applied for PDSCH and PUSCH. In another specific example embodiment, the same beam mapping pattern is conditionally applied for PDSCH, PUSCH and PUCCH.

In some embodiments, the at least one transmission parameter (such as, the transmission schemes, the repetition number, the beam mapping and so on) may be configured for each channel/signal separately.

### Example Processed for Applying Timing for PUSCH

In the related solution, precoding information is needed for PUSCH transmission. However, according to the legacy procedure, the at least DCI message indicting the TCI state(s) and the precoding information (SRI or SRI and TPMI). However, the precoding information transmitted together with the TCI states is not the latest precoding information, which may not suitable for the PUSCH transmission. In other words, the PUSCH precoding information may be unknown after beam switching timing (or beam application timing, BAT).

According to some embodiments of the present disclosure, some additional time for obtaining and indicating precoding information for PUSCH is considered.

Reference is made to FIG. 3C, which illustrates signaling flow 340 for communication according to some example embodiments of the present disclosure. As illustrated in FIG. 3C, the terminal device 120 receives 342 at least one DCI message from the network device 110, where the at least one DCI message indicates at least one TCI state to be applied by the terminal device 120.

Next, the terminal device 120 performs 344 a PUSCH transmission. In one specific example embodiment, the terminal device 120 performs the PUSCH transmission based on precoding information determined by a latest SRS transmission transmitted with the at least one indicated TCI states. In another specific example embodiment, the terminal device 120 applies the at least one indicated TCI state to the PUSCH transmission if the latest SRS transmission is transmitted based on the at least one indicated TCI state. In addition, the latest SRS transmission refers to the latest transmission of SRS resource identified by SRI in DCI message for uplink grant.

In some embodiments, the terminal device 120 performs the PUSCH transmission by continuing to apply a currently-applied TCI state until obtaining precoding information corresponding to the indicated TCI state. In some other embodiments, the terminal device 120 does not expect to be scheduled to perform the PUSCH transmission until obtaining precoding information corresponding to the indicated TCI state. In some other embodiments, the terminal device 120 does not expect to be scheduled to perform the PUSCH transmission with more than 1 layer until obtaining precoding information corresponding to the indicated TCI state. In some embodiments, the terminal device 120 applies a specific precoding information/matrix (e.g., an identity matrix, a random precoding matrix, a precoder cycling, a latest precoding matrix, a precoding matrix with lowest/highest identity, etc.) to perform the PUSCH transmission.

Accordingly, in some embodiments, after transmitting an acknowledgement for the at least one DCI message, the terminal device 120 delays to apply the at least one TCI state to the PUSCH transmission with the network until obtaining precoding information corresponding to the at least one TCI state.

In some embodiments, the SRS resource or SRS resource set are configured for CB and NCB PUSCH transmission, respectively and the latest precoding information may be obtained by a SRS transmission between the terminal device 120 and the network device 110. For example, the beam (corresponding to the indicated TCI state) for PUSCH is only updated after corresponding SRS transmission.

In some embodiments, if the most recent SRS transmission is based on newly-indicated TCI states, the terminal device 120 performs the PUSCH transmission by using the newly-indicated TCI states. Otherwise, the terminal device 120 performs the PUSCH transmission by continuing to using the currently-used TCI states.

In some embodiments, the terminal device 120 performs a SRS transmission with the network by applying the at least one TCI state (i.e., the uplink beam for transmitting the SRS resources is updated by the newly-indicated TCI state), and then receives information for determining the precoding information corresponding to the at least one TCI state from the network. With this information, the terminal device 120 may applies the newly-indicated TCI state to the PUSCH transmission.

Further, for NCB PUSCH transmission, additional associated RS (such CSI-RS) may be configured and the associated RS is transmitted/received with the newly-indicated TCI state. Further, the terminal device 120 determines the candidate precoding information (i.e., making the precoder calculation) based on the new measurement of associated RS.

In some embodiments, the terminal device 120 applies the newly-indicated TCI state to the SRS transmission after X time units offset after transmitting the ACK for the DCI messages (i.e., right after beam application timing).

In some embodiments, if the PUSCH transmission is a NCB PUSCH transmission, the terminal device 120 receives a RS and determines candidate precoding information based on the RS. Next, the terminal device 120 performs the SRS transmission based on the candidate precoding information. With this candidate precoding information, the network device 110 may determines the target precoding information and transmits the target precoding information to the terminal device 120 via such as SRI.

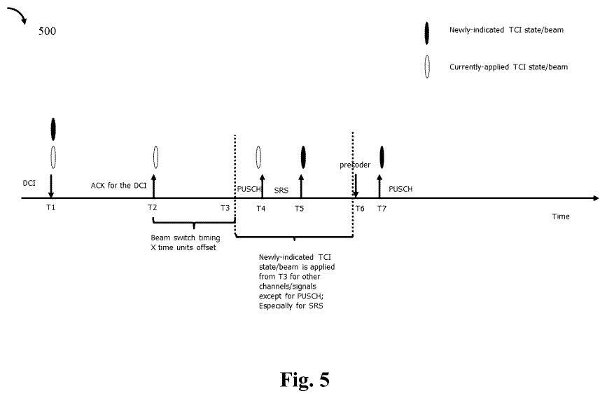

Reference is now made to FIG. 5, which illustrates an example applying timing 500. As illustrated in FIG. 5, at time point T1, the terminal device 120 receives the DCI message indicating a newly-indicated TCI state. Next, the terminal device 120 transmits an ACK for the DCI message at time point T2. The newly-indicated TCI state is applied from T3 (i.e. right after the beam switch timing, X time units offset after transmitting the ACK) for other channels/signals (especially for the SRS transmission) except for PUSCH. As illustrated in FIG. 5, the terminal device 120 transmits a PUSCH transmission via the currently-used TCI state at time T4 and transmits a SRS transmission via the newly-indicated TCI state at time T5.

Based on the SRS transmission, the network device 110 may determine the precoding information. As can be seen in FIG. 5, at time point T6, the network device 110 transmits the precoding information to the terminal device 120.

Based on the precoding information, the terminal device 120 may apply the newly-indicated TCI state to the PUSCH transmission. As can be seen in FIG. 5, the terminal device 120 transmits a PUSCH transmission via the newly-indicated TCI state at time T7.

In some embodiments, as for CB PUSCH transmission, the transmission precoder is selected from the uplink codebook that has a number of antenna ports equal to higher layer parameter nrofSRS-Ports in SRS-Config. When the terminal device 120 is configured with the higher layer parameter txConfig set to ‘codebook’, the terminal device 120 is configured with at least one SRS resource. The indicated SRI in slot n is associated with the most recent transmission of SRS resource identified by the SRI, where the SRS resource is prior to the PDCCH carrying the SRI and is after the beam application timing (e.g., BeamAppTime) after the last symbol of PUCCH with HARQ-ACK information corresponding to the DCI carrying the TCI state indication.

In some embodiments, as for NCB PUSCH transmission, only one SRS resource set can be configured in srs-ResourceSetToAddModList with higher layer parameter usage in SRS-ResourceSet set to ‘nonCodebook’, and only one SRS resource set can be configured in srs-ResourceSetToAddModListDCI-0-2 with higher layer parameter usage in SRS-ResourceSet set to ‘nonCodebook’. The maximum number of SRS resources that can be configured for non-codebook based uplink transmission is 4. The indicated SRI in slot n is associated with the most recent transmission of SRS resource(s) identified by the SRI, where the SRS transmission is prior to the PDCCH carrying the SRI and is after the beam application timing (e.g., BeamAppTime) after the last symbol of PUCCH with HARQ-ACK information corresponding to the DCI carrying the TCI state indication.

In some embodiments, when the terminal device 120 would transmit the last symbol of a PUCCH with HARQ-ACK information corresponding to the DCI carrying the TCI-State indication and the indicated TCI-State is different from the previously indicated one, the indicated [TCI-State] with [tci-Stateld_r17] should be applied starting from the first slot that is at least BeamAppTime symbols after the last symbol of the PUCCH, except PUSCH. The first slot and the BeamAppTime symbols are both determined on the carrier with the smallest subcarrier spacing (SCS) among the carrier(s) applying the beam indication. The UE can assume that one BeamAppTime for a given SCS is configured for all CCs in the same CC list configured by simultaneousTCI-UpdateList1 or simultaneousTCI-UpdateList2. The UE can assume one indicated [TCI-State] with [tci-Stateld_r17] for downlink and uplink or separately one indicated [TCI-State] with [tci-Stateld_r17] for UL at a time. In addition, as for PUSCH, the indicated [TCI-State] with [tci-StateId_r17] should be applied after most recent SRS transmission applying the indicated [TCI-State] with [tci-StateId_r17].

Further, in case of the multi-TRP transmission/multi TCI state mode, the above discussed should be applied per TRP/TCI state.

Specifically, in some embodiments, if a number of the at least one TCI state is bigger than one, the processes for the at least one TCI state are performed independently. In one specific example embodiment, the terminal device 120 performs a first PUSCH transmission based on first precoding information determined by a latest first SRS transmission transmitted with the indicated first TCI states; while performs a second PUSCH transmission based on second precoding information determined by a latest SRS transmission transmitted with the indicated second TCI states.

In one specific example embodiment, the terminal device 120 applies the indicated first TCI state to the PUSCH transmission if a latest first SRS transmission is transmitted based on the indicated first TCI state while applies the indicated second TCI state to the PUSCH transmission if a latest second SRS transmission is transmitted based on the indicated second TCI state.

In a further specific example embodiment, the terminal device 120 delays to apply the first TCI state to the PUSCH transmission until obtaining first precoding information corresponding to the first TCI state and delays to apply the second TCI state to the PUSCH transmission until obtaining second precoding information corresponding to the second TCI state.

In some embodiments, there are N newly-indicated TCI states and each newly-indicated TCI state corresponds a corresponding SRS resource/SRS resource set. Thus, N SRS resources or N SRS resource sets are needed. In some embodiments, the N SRS resources or N SRS resource sets are configured for codebook-based and non-codebook-based PUSCH transmission respectively.

Accordingly, the SRS transmissions corresponding to N newly-indicated TCI states are required before any PUSCH transmission since the precoding information need to be determined at the network by measurement of those SRSs.

In some embodiments, each of N SRS resources/resource sets may be linked to each of N newly-indicated state, respectively (i.e., one to one mapping). Alternatively, in some other embodiments, one SRS resource/resource set is configured with N uplink beams (i.e., one to multiple mapping)

Additionally, in some embodiments, for NCB, N associated CSI-RSs also are needed be configured. Further, in some embodiments, for NCB, the precoder information calculation is performed based on N configured associated CSI-RS.

In some embodiments, the uplink beam for transmitting the SRS resources can be updated based on the newly-indicated TCI states right after the beam application timing.

### Example Processed for Beam Failure Recovery

In the related solution, a beam failure recovery request (BFRQ) is reported via a beam expected to be used (represented to be “qnew”), which causes that the BFRQ cannot be reported to the network in time.

According to some embodiments of the present disclosure, if there is an available uplink TCI state, the BFRQ may be reported with the available uplink TCI state. In this way, the BFRQ may be reported to the network in time.

Reference is made to FIG. 3D, which illustrates signaling flow 360 for communication according to some example embodiments of the present disclosure. In operation, the terminal device 120 receives 362 a downlink RS. By measuring the RS, the terminal device 120 may detect 364 a beam failure. Next, if there is an available uplink TCI state, the terminal device 120 may transmit 366 the BFRQ with the available uplink TCI state. The network may transmit 368 a response of the BFRQ to respond the BFRQ.

In some embodiments, the BFRQ is a beam failure report (BFR) MAC CE carried on PUSCH. Additionally, in some embodiments, the terminal device 120 also transmit a PUCCH-scheduling request (SR) (PUCCH-SR) with the available uplink TCI state.

In some embodiments, the terminal device 120 transmits the BFRQ with both the available uplink TCI state and the beam expected to be used (i.e., “qnew”). Alternatively, in some other embodiments, the terminal device 120 transmits the BFRQ with the available uplink TCI state if no new beam can be found, for example, no new beam can satisfy the configured candidate beam RSRP threshold.

In some embodiments, the terminal device 120 is configured with at least one TCI state used for uplink transmission and at least one TCI state used for downlink transmission, and a number of the TCI state used for uplink transmission is no less than a number of TCI state used for downlink transmission. In this way, it is ensured that there must be an available uplink TCI state.

In one specific example embodiment, the terminal device 120 is configured with a joint TCI state associated with the first TRP 130-1 while configured with an uplink TCI state/further joint TCI state associated with the second TRP 130-2. Thus, in case that the beam failure on the first TRP 130-1 is detected, the beam failure report may be transmitted with the uplink TCI state/further joint TCI state associated with the second TRP 130-2.

In another specific example embodiment, the terminal device 120 is configured with a downlink TCI state associated with the first TRP 130-1 while configured with an uplink TCI state/further joint TCI state associated with the second TRP 130-2. Thus, in case that the beam failure on the first TRP 130-1 is detected, the beam failure report may be transmitted with the uplink TCI state/further joint TCI state associated with the second TRP 130-2.

In some embodiments, if the beam failure is associated with a joint TCI state, the terminal device 120 disables an uplink transmission (such as, a PUCCH transmission and a PUSCH transmission) associated with the joint TCI state. Alternatively, if the beam failure is associated with a joint TCI state, the terminal device 120 transmits 370 the uplink transmission associated with the joint TCI state with the available uplink TCI state.

Additionally, in some embodiments, the terminal device 120 starts to transmit the uplink transmission associated with the joint TCI state with the available uplink TCI state in response to receiving the response of the BFRQ.

Additionally, in some embodiments, after receiving the response of the BFRQ, the uplink transmission associated with the joint TCI state may be performed with both the available uplink TCI state and the beam expected to be used (i.e., “qnew”), because the reported beam (“qnew”) has been confirmed by the network.

In some embodiments, if the beam failure is associated with a joint TCI state, the terminal device 120 switches to a single TCI mode and keeps the single TCI mode until a multi-TCI mode switch condition meets (for example, receiving a message to trigger a switch to the multi-TCI mode).

In some embodiments, for the primary cell (PCell) or the primary secondary cell (PScell), after 28 symbols from a last symbol of a first PDCCH reception in a search space set provided by recoverySearchSpaceId for which the terminal device 120 detects a DCI format with cyclic redundancy check (CRC) scrambled by cell radio network temporary identifier (C-RNTI) or modulation and coding scheme (MCS)-C-RNTI and until the terminal device 120 receives an activation command for PUCCH-SpatialRelationInfo or is provided PUCCH-SpatialRelationInfo for PUCCH resource(s), the terminal device 120 transmits a PUCCH on a same cell as the physical random access channel (PRACH) transmission using the following:
a same spatial filter as for the last PRACH transmission;
a power determined with qᵤ=0, q_{d}=q_{new}, and l=0,

In some embodiments, if the terminal devoice 120 is provided with an extra uplink TCI state (i.e., the available uplink TCI state), the terminal devoice 120 transmits a PUCCH on a same cell with the extra TCI state using the following:
a same spatial filter as indicated in the TCI state;
a power determined by the power control parameters in the TCI state.

In some embodiments, for the PCell or the PSCell, if BFR MAC CE is transmitted in Msg3 or MsgA of contention based random access procedure, and if a PUCCH resource is provided with PUCCH-SpatialRelationInfo, after 28 symbols from the last symbol of the PDCCH reception that determines the completion of the contention based random access procedure, the terminal devoice 120 transmits the PUCCH on a same cell as the PRACH transmission using the following:
a same spatial filter as for the last PRACH transmission;
a power determined with qᵤ=0, q_{d}=q_{new}, and l=0, where q_{new} is the SS/PBCH block index selected for the last PRACH transmission.

In some embodiments, if the terminal devoice 120 is provided with an extra uplink TCI state (i.e., the available uplink TCI state), the terminal devoice 120 transmits a PUCCH on a same cell with the extra TCI state using the following:
a same spatial filter as indicated in the TCI state
a power determined by the power control parameters in the TCI state

In some embodiments, a terminal devoice 120 can be provided, by schedulingRequestID-BFR-SCell, a configuration for PUCCH transmission with a link recovery request (LRR). The terminal devoice 120 can transmit in a first PUSCH MAC CE providing index(es) for at least corresponding SCell(s) with radio link quality worse than Q_{out,LR}, indication(s) of presence of q_{new} for corresponding SCell(s), and index(es) q_{new} for a periodic CSI-RS configuration or for a SS/PBCH block provided by higher layers, if any, for corresponding SCell(s). After 28 symbols from a last symbol of a PDCCH reception with a DCI format scheduling a PUSCH transmission with a same HARQ process number as for the transmission of the first PUSCH and having a toggled NDI field value, the terminal device 120
monitors PDCCH in all CORESETs on the SCell(s) indicated by the MAC CE using the same antenna port quasi co-location parameters as the ones associated with the corresponding index(es) q_{new}, if any;
transmits PUCCH on a PUCCH-SCell using a same spatial domain filter as the one corresponding to q_{new}, if any, for periodic CSI-RS or SS/PBCH block reception, and using a power determined with qᵤ=0, q_{d}=q_{new}, and l=0, if
   the terminal device 120 is provided PUCCH-SpatialRelationInfo for the PUCCH,
   a PUCCH with the LRR was either not transmitted or was transmitted on the PCell or the PSCell, and
   the PUCCH-SCell is included in the SCell(s) indicated by the MAC-CE;
transmits PUCCH on a PUCCH-SCell using a same spatial domain filter as the one corresponding to an uplink TCI state if any, and using a power determined power determined by the power control parameters in the TCI state if
   If the UE is provided with an extra uplink TCI state (i.e., the available uplink TCI state).

### Example Methods

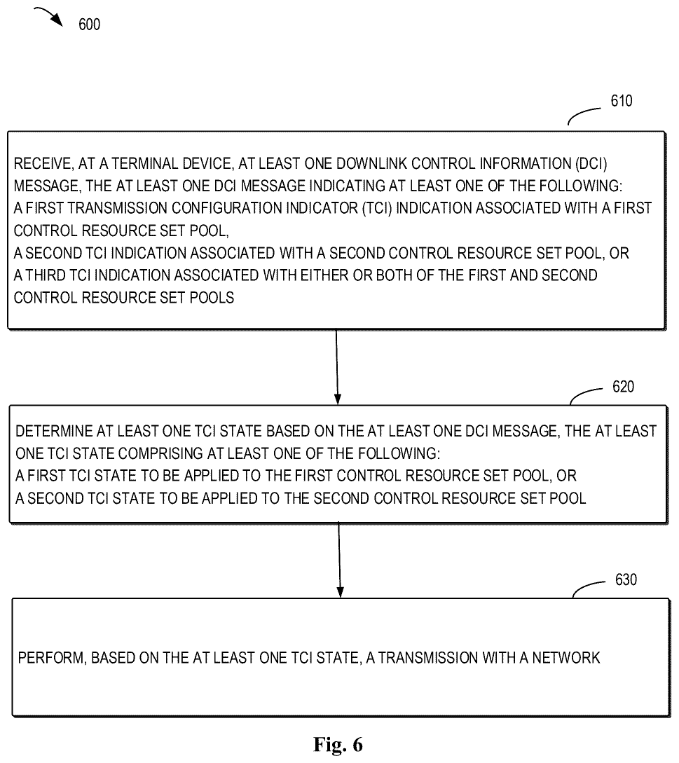

FIG. 6 illustrates a flowchart of an example method 600 in accordance with some embodiments of the present disclosure. For example, the method 600 can be implemented at the terminal device 120 as shown in FIGS. 1A to 1C.

At block 610, the terminal device 120 receives at least one DCI message, the at least one DCI message indicating at least one of the following: a first TCI indication associated with a first control resource set pool, a second TCI indication associated with a second control resource set pool, or a third TCI indication associated with either or both of the first and second control resource set pools.

At block 620, the terminal device 120 determines at least one TCI state based on the at least one DCI message, the at least one TCI state comprising at least one of the following: a first TCI state to be applied to the first control resource set pool, or a second TCI state to be applied to the second control resource set pool.

At block 630, the terminal device 120 performs a transmission with a network based on the at least one TCI state.

In some embodiments, the terminal device 120 performs a PUSCH transmission based on the at least one TCI state by at least one of the following: performing the PUSCH transmission based on precoding information determined by a latest SRS transmission transmitted with the at least one TCI states; performing a first PUSCH transmission based on first precoding information determined by a latest first SRS transmission transmitted with the indicated first TCI states; or performing a second PUSCH transmission based on second precoding information determined by a latest SRS transmission transmitted with the indicated second TCI states.

In some embodiments, the at least one DCI message is a single DCI message comprises: a first TCI field indicating the first TCI indication, and a second TCI field indicating the second TCI indication. The terminal device receives: a first MAC CE message indicating at least one first mapping and a second MAC CE message indicating at least one second mapping, where each first mapping indicating a first correspondence between a first TCI codepoint and a first TCI state configured for the first control resource set pool and each second mapping indicating a second correspondence between a second TCI codepoint and a second TCI state configured for the first control resource set pool.

In some embodiments, the terminal device 120 receives an indication indicating a presence of the second TCI field from the network.

In some embodiments, the at least one DCI message is a single DCI comprising a third TCI state field indicating the third TCI indication. The terminal device 120 receives a third MAC CE message indicating at least one third mapping from the network, where each third mapping indicates a third correspondence between a third TCI codepoint and at least one third TCI state, each of the at least one third TCI state being configured for either of the first and second control resource set pools.

In some embodiments, a total bit size for indicating TCI information depends on at least one of the following: whether the at least one DCI messages is a single DCI or multiple DCI messages, a number of TCI fields comprised in at least one DCI messages, respective bit sizes of the TCI fields, or a number of TCI states indicated by the at least one DCI message.

In some embodiments, the terminal device 120 performs the transmission with the network comprises performing at least one of the following: applying the first TCI state to a combination of physical channels associated with the first control resource set pool; or applying the second TCI state to a combination of physical channels associated with the second control resource set pool.

In some embodiments, the at least one DCI message is multiple DCI messages comprising: a first DCI message comprising a first TCI field indicating the first TCI indication, and a second DCI message comprising a second TCI field indicating the second TCI indication.

In some embodiments, if the at least one TCI state overlaps with at least one currently-applied TCI state, the terminal device 120 applies the overlapped TCI state prior to applying other TCI state of the at least one TCI state.

In some embodiments, the terminal device 120 applies the overlapped TCI state upon transmitting an acknowledgement for the at least one DCI message to the network.

In some embodiments, the terminal device 120 applies the other TCI state after a certain period since transmitting the acknowledgement for the at least one DCI message to the network.

In some embodiments, the at least one DCI message is a single DCI message and is used to trigger a switch among a multiple TCI mode and a single TCI mode.

In some embodiments, the at least one DCI message is multiple DCI messages. The terminal device 120 applies the first TCI state and the second TCI state at a first starting point associated with the first control resource set pool and a second starting point associated with the second control resource set pool, respectively.

In some embodiments, the terminal device 120 receives, from the network, a configuration message, indicating: at least one first transmission occasion associated with the first TCI state, and at least one second transmission occasion associated with the second TCI state.

In some embodiments, the at least one second transmission occasion is linked to the at least one first transmission occasion by at least one pre-configuration parameter.

In some embodiments, the terminal device 120 activates the at least one first transmission occasion and the at least one second transmission occasion based on at least one of the following: the at least one TCI state, or a switch among a multiple TCI mode and a single TCI mode.

In some embodiments, at least one transmission parameter associated with the at least one first transmission occasion is the same with at least second transmission parameter associated with the at least one second transmission occasion.

In some embodiments, the at least transmission parameter comprises at least one of the following: a transmission scheme, a repetition number, a beam mapping pattern, or a TCI mapping pattern.

In some embodiments, the at least one first transmission occasion and the at least one second transmission occasion are associated with at least one of the following: PDCCH, PDSCH, PUCCH, or PUSCH.

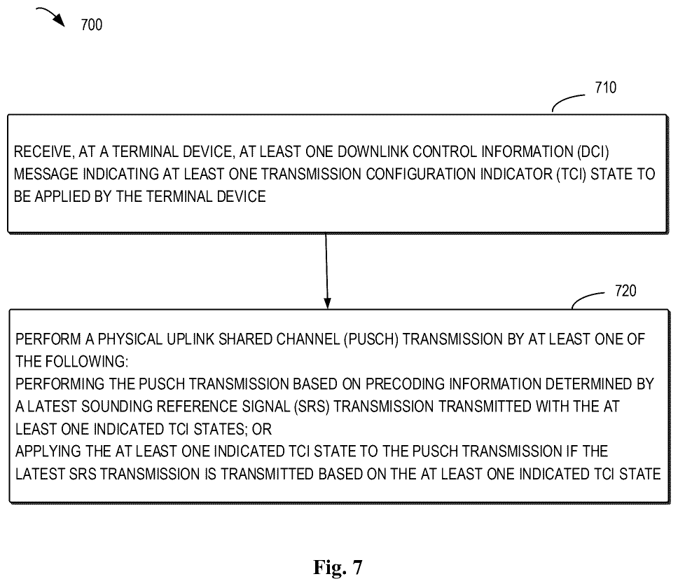

FIG. 7 illustrates a flowchart of an example method 700 in accordance with some embodiments of the present disclosure. For example, the method 700 can be implemented at the terminal device 120 as shown in FIGS. 1A to 1C.

At block 710, the terminal device 120 receives at least one DCI message indicating at least one TCI state to be applied by the terminal device 120.

At block 720, the terminal device 120 performs a PUSCH transmission by at least one of the following: performing the PUSCH transmission based on precoding information determined by a latest SRS transmission transmitted with the at least one indicated TCI states; or applying the at least one indicated TCI state to the PUSCH transmission if the latest SRS transmission is transmitted based on the at least one indicated TCI state.

In some embodiments, after transmitting an acknowledgement for the at least one DCI message, the terminal device 120 delays to apply the at least one indicated TCI state to the PUSCH transmission until obtaining the precoding information corresponding to the at least one indicated TCI state.

In some embodiments, the terminal device 120 delays to apply the at least one indicated TCI state by: performing a SRS transmission with a network by applying the at least one indicated TCI state; receiving, from the network, information for determining the precoding information corresponding to the at least one indicated TCI state; and applying the at least one indicated TCI state to the PUSCH transmission.

In some embodiments, if the PUSCH transmission is a NCB PUSCH transmission, the terminal device 120 performs the SRS transmission by: receiving a RS from the network; determining candidate precoding information based on the RS; and performing the SRS transmission based on the candidate precoding information.

In some embodiments, if the at least one indicated TCI state comprises a first TCI state and a second TCI state, the terminal device 120 performs the PUSCH transmission by: performing a first PUSCH transmission based on first precoding information determined by a latest first SRS transmission transmitted with the indicated first TCI states; and performing a second PUSCH transmission based on second precoding information determined by a latest SRS transmission transmitted with the indicated second TCI states.

In some embodiments, if the at least one indicated TCI state comprises a first TCI state and a second TCI state, the terminal device 120 performs the PUSCH transmission by: applying the indicated first TCI state to the PUSCH transmission if a latest first SRS transmission is transmitted based on the indicated first TCI state; and applying the indicated second TCI state to the PUSCH transmission if a latest second SRS transmission is transmitted based on the indicated second TCI state.

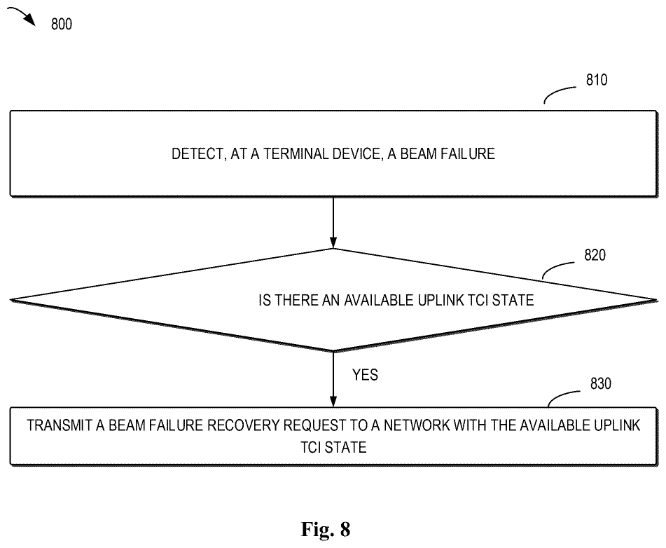

FIG. 8 illustrates a flowchart of an example method 800 in accordance with some embodiments of the present disclosure. For example, the method 800 can be implemented at the terminal device 120 as shown in FIGS. 1A to 1C.

At block 810, the terminal device 120 detects a beam failure.

At block 820, the terminal device 120 determines whether there is an available uplink TCI state.

At block 830, the terminal device 120 transmits a beam failure recovery request to a network with the available uplink TCI state in response to a determination that there is an available uplink TCI state.

In some embodiments, if the beam failure is associated with a joint TCI state, the terminal device 120 disables an uplink transmission associated with the joint TCI state, or transmits the uplink transmission associated with the joint TCI state with the available uplink TCI state.

In some embodiments, the terminal device 120 transmits the uplink transmission associated with the joint TCI state with the available uplink TCI state by: in response to receiving a response of the beam failure recovery request from the network, starting to transmit the uplink transmission associated with the joint TCI state with the available uplink TCI state.

In some embodiments, if the beam failure is associated with a joint TCI state, the terminal device 120 switches to a single TCI mode; and keeps the single TCI mode until a multiple TCI mode switch condition meets.

In some embodiments, the terminal device 120 is configured with at least one TCI state used for uplink transmission and at least one TCI state used for downlink transmission, and a number of the TCI state used for uplink transmission is no less than a number of TCI state used for downlink transmission.

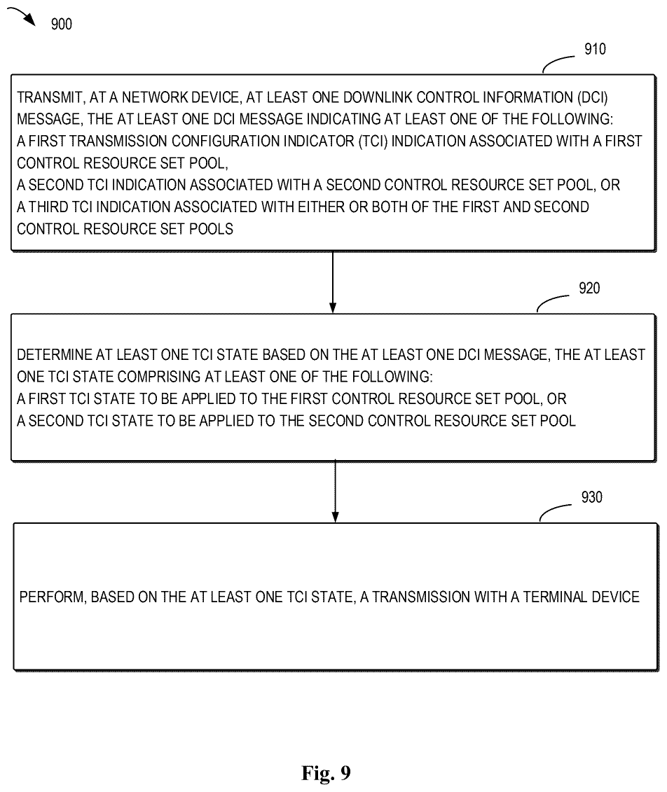

FIG. 9 illustrates a flowchart of an example method 900 in accordance with some embodiments of the present disclosure. For example, the method 900 can be implemented at the network device 110 as shown in FIGS. 1A to 1C.

At block 910, the network device 110 transmits at least one DCI message, the at least one DCI message indicating at least one of the following: a first TCI indication associated with a first control resource set pool, a second TCI indication associated with a second control resource set pool, or a third TCI indication associated with either or both of the first and second control resource set pools.

At block 920, the network device 110 determines at least one TCI state based on the at least one DCI message, the at least one TCI state comprising at least one of the following: a first TCI state to be applied to the first control resource set pool, or a second TCI state to be applied to the second control resource set pool.

At block 930, the network device 110 performs a transmission with a terminal device 120 based on the at least one TCI state.

In some embodiments, the network device 110 performs a PUSCH transmission based on the at least one TCI state by at least one of the following: performing the PUSCH transmission based on precoding information determined by a latest SRS transmission transmitted with the at least one TCI states; performing a first PUSCH transmission based on first precoding information determined by a latest first SRS transmission transmitted with the indicated first TCI states; or performing a second PUSCH transmission based on second precoding information determined by a latest SRS transmission transmitted with the indicated second TCI states.

In some embodiments, the at least one DCI message is a single DCI message comprises: a first TCI field indicating the first TCI indication, and a second TCI field indicating the second TCI indication. The network device 110 transmits a first MAC CE message indicating at least one first mapping and a second MAC CE message indicating at least one second mapping, where each first mapping indicating a first correspondence between a first TCI codepoint and a first TCI state configured for the first control resource set pool and each second mapping indicating a second correspondence between a second TCI codepoint and a second TCI state configured for the first control resource set pool.

In some embodiments, the network device 110 transmits an indication indicating a presence of the second TCI field to the terminal device 120.

In some embodiments, the at least one DCI message is a single DCI message comprising a third TCI state field indicating the third TCI indication. The network device 110 transmits a third MAC CE message indicating at least one third mapping, where each third mapping indicates a third correspondence between a third TCI codepoint and at least one third TCI state, the at least one third TCI state being configured for either or both of the first and second control resource set pools.

In some embodiments, a total bit size for indicating TCI information depends on at least one of the following: whether the at least one DCI messages is a single DCI or multiple DCI messages, a number of TCI fields comprised in at least one DCI messages, respective bit sizes of the TCI fields, or a number of TCI states indicated by the at least one DCI message.

In some embodiments, the network device 110 performs the transmission with the terminal device 120 comprises performing at least one of the following: applying the first TCI state to a combination of physical channels associated with the first control resource set pool; or applying the second TCI state to a combination of physical channels associated with the second control resource set pool.

In some embodiments, the at least one DCI message is multiple DCI messages comprising: a first DCI message comprising a first TCI field indicating the first TCI indication, and a second DCI message comprising a second TCI field indicating the second TCI indication.

In some embodiments, if the at least one TCI state overlaps with at least one currently-applied TCI state, the network device 110 performs the transmission with the terminal device 120 by: applying the overlapped TCI state prior to applying other TCI state of the at least one TCI state.

In some embodiments, the network device 110 applies the overlapped TCI state prior to applying the other TCI state of the at least one TCI state by: applying the overlapped TCI state upon receiving an acknowledgement for the at least one DCI message from the terminal device 120; or applying the other TCI state after a certain period after receiving the acknowledgement for the at least one DCI message from the terminal device 120.

In some embodiments, the at least one DCI message is a single DCI message and is used to trigger a switch among a multiple TCI mode and a single TCI mode.

In some embodiments, the at least one DCI message is multiple DCI messages and the network device 110 applies the overlapped TCI state by: applying the first TCI state and the second TCI state at a first starting point associated with the first control resource set pool and a second starting point associated with the second control resource set pool, respectively.

In some embodiments, the network device 110 transmits a configuration message to the terminal device 120, where the configuration message, indicating: at least one first transmission occasion associated with the first TCI state, and at least one second transmission occasion associated with the second TCI state.

In some embodiments, the at least one second transmission occasion is linked to the at least one first transmission occasion by at least one pre-configuration parameter.

In some embodiments, the network device 110 activates the at least one first transmission occasion and the at least one second transmission occasion based on at least one of the following: the at least one TCI state, or a switch among a multiple TCI mode and a single TCI mode.

In some embodiments, at least one transmission parameter associated with the at least one first transmission occasion is the same with at least second transmission parameter associated with the at least one second transmission occasion.

In some embodiments, the at least transmission parameter comprises at least one of the following: a transmission scheme, a repetition number, or a beam mapping pattern, or a TCI mapping pattern.

In some embodiments, the at least one first transmission occasion and the at least one second transmission occasion are associated with at least one of the following: PDCCH, PDSCH, PUCCH, or PUSCH.

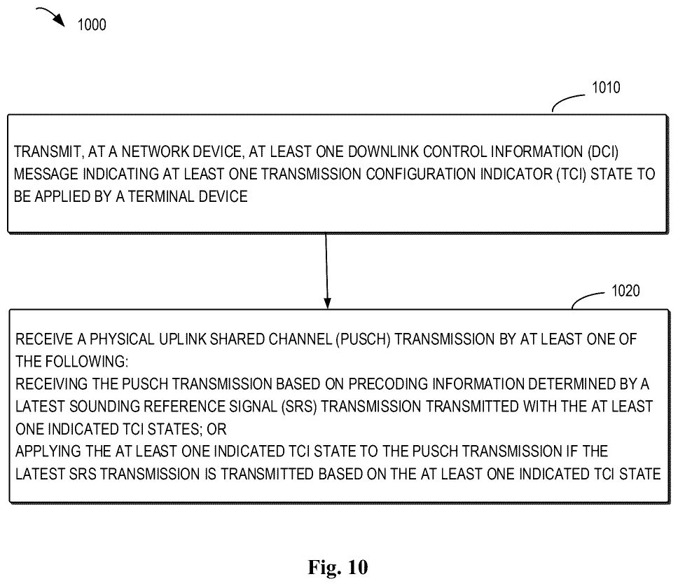

FIG. 10 illustrates a flowchart of an example method 1000 in accordance with some embodiments of the present disclosure. For example, the method 1000 can be implemented at the network device 110 as shown in FIGS. 1A to 1C.

At block 1010, the network device 110 transmits at least one DCI message indicating at least one TCI state to be applied by a terminal device 120.

At block 1020, the network device 110 receives a PUSCH transmission by at least one of the following: receiving the PUSCH transmission based on precoding information determined by a latest SRS transmission transmitted with the at least one indicated TCI states; or applying the at least one indicated TCI state to the PUSCH transmission if the latest SRS transmission is transmitted based on the at least one indicated TCI state.

In some embodiments, the network device 110 performs the PUSCH transmission by: after transmitting an acknowledgement for the at least one DCI message, delaying to apply the at least one indicated TCI state to the PUSCH transmission until obtaining the precoding information corresponding to the at least one indicated TCI state.

In some embodiments, the network device 110 delays to apply the at least one indicated TCI state by: receiving a SRS transmission with a network by applying the at least one indicated TCI state; determining, the precoding information corresponding to the at least one TCI state based on the SRS transmission; and applying the at least one indicated TCI state to the PUSCH transmission.

In some embodiments, if the PUSCH transmission is a NCB PUSCH transmission, the network device 110 receives the SRS transmission by: transmitting a RS to the terminal device 120; receiving the SRS transmission transmitted by the terminal device 120 based on candidate precoding information, the candidate precoding information being determined by the terminal device 120 based on the RS.

In some embodiments, if the at least one indicated TCI state comprises a first TCI state and a second TCI state, the network device 110 performs the PUSCH transmission by: performing a first PUSCH transmission based on first precoding information determined by a latest first SRS transmission transmitted with the indicated first TCI states; and performing a second PUSCH transmission based on second precoding information determined by a latest SRS transmission transmitted with the indicated second TCI states.

In some embodiments, if the at least one indicated TCI state comprises a first TCI state and a second TCI state, the network device 110 performs the PUSCH transmission by: applying the indicated first TCI state to the PUSCH transmission if a latest first SRS transmission is transmitted based on the indicated first TCI state; and applying the indicated second TCI state to the PUSCH transmission if a latest second SRS transmission is transmitted based on the indicated second TCI state.

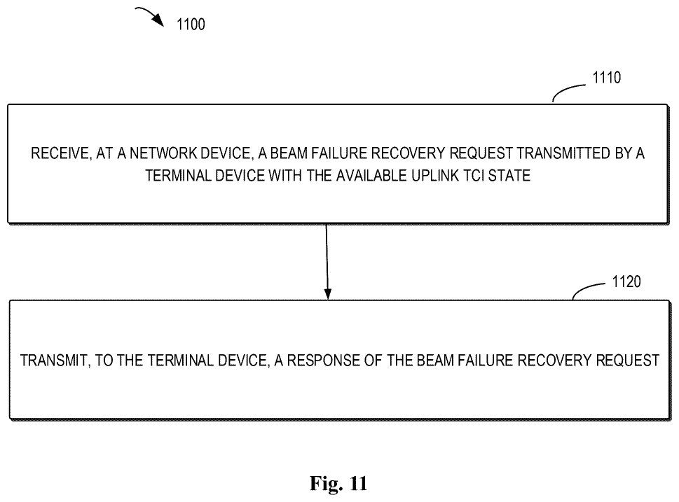

FIG. 11 illustrates a flowchart of an example method 1100 in accordance with some embodiments of the present disclosure. For example, the method 1100 can be implemented at the network device 110 as shown in FIGS. 1A to 1C.

At block 1110, the network device 110 receives a beam failure recovery request transmitted by a terminal device 120 with the available uplink TCI state.

At block 1120, the network device 110 transmits a response of the beam failure recovery request to the terminal device 120.

In some embodiments, if the beam failure is associated with a joint TCI state, the network device 110 disables an uplink transmission associated with the joint TCI state, or receives the uplink transmission associated with the joint TCI state with the available uplink TCI state.

In some embodiments, the network device 110 receives the uplink transmission associated with the joint TCI state with the available uplink TCI state by: in response to transmitting a response of the beam failure recovery request from the network device 110, starting to receive the uplink transmission associated with the joint TCI state with the available uplink TCI state.

In some embodiments, if the beam failure is associated with a joint TCI state, the network device 110 switches to a single TCI mode; and keeps the single TCI mode until a multiple TCI mode switch condition meets.

In some embodiments, the terminal device 120 is configured with at least one TCI state used for uplink transmission and at least one TCI state used for downlink transmission, and a number of the TCI state used for uplink transmission is no less than a number of TCI state used for downlink transmission.

### Example Devices

In some example embodiments, the terminal device 120 comprises circuitry configured to: receive at least one DCI message, the at least one DCI message indicating at least one of the following: a first TCI indication associated with a first control resource set pool, a second TCI indication associated with a second control resource set pool, or a third TCI indication associated with either or both of the first and second control resource set pools; determine at least one TCI state based on the at least one DCI message, the at least one TCI state comprising at least one of the following: a first TCI state to be applied to the first control resource set pool, or a second TCI state to be applied to the second control resource set pool; and perform a transmission with a network based on the at least one TCI state.

In some embodiments, the circuitry is further configured to: perform a PUSCH transmission based on the at least one TCI state by at least one of the following: performing the PUSCH transmission based on precoding information determined by a latest SRS transmission transmitted with the at least one TCI states; performing a first PUSCH transmission based on first precoding information determined by a latest first SRS transmission transmitted with the indicated first TCI states; or performing a second PUSCH transmission based on second precoding information determined by a latest SRS transmission transmitted with the indicated second TCI states.

In some example embodiments, the at least one DCI message is a single DCI message comprises: a first TCI field indicating the first TCI indication, and a second TCI field indicating the second TCI indication. The circuitry is further configured to: a first MAC CE message indicating at least one first mapping and a second MAC CE message indicating at least one second mapping, where each first mapping indicating a first correspondence between a first TCI codepoint and a first TCI state configured for the first control resource set pool and each second mapping indicating a second correspondence between a second TCI codepoint and a second TCI state configured for the first control resource set pool.

In some embodiments, the circuitry is further configured to: receive an indication indicating a presence of the second TCI field from the network.

In some embodiments, the at least one DCI message is a single DCI comprising a third TCI state field indicating the third TCI indication. The circuitry is further configured to: receive a third MAC CE message indicating at least one third mapping from the network, where each third mapping indicates a third correspondence between a third TCI codepoint and at least one third TCI state, each of the at least one third TCI state being configured for either of the first and second control resource set pools.

In some embodiments, a total bit size for indicating TCI information depends on at least one of the following: whether the at least one DCI messages is a single DCI or multiple DCI messages, a number of TCI fields comprised in at least one DCI messages, respective bit sizes of the TCI fields, or a number of TCI states indicated by the at least one DCI message.

In some embodiments, the circuitry is further configured to: perform the transmission with the network comprises performing at least one of the following: applying the first TCI state to a combination of physical channels associated with the first control resource set pool; or applying the second TCI state to a combination of physical channels associated with the second control resource set pool.

In some embodiments, the at least one DCI message is multiple DCI messages comprising: a first DCI message comprising a first TCI field indicating the first TCI indication, and a second DCI message comprising a second TCI field indicating the second TCI indication.

In some embodiments, if the at least one TCI state overlaps with at least one currently-applied TCI state, the circuitry is further configured to: apply the overlapped TCI state prior to applying other TCI state of the at least one TCI state.

In some embodiments, the circuitry is further configured to: apply the overlapped TCI state upon transmitting an acknowledgement for the at least one DCI message to the network.

In some embodiments, the circuitry is further configured to: apply the other TCI state after a certain period since transmitting the acknowledgement for the at least one DCI message to the network.

In some embodiments, the at least one DCI message is a single DCI message and is used to trigger a switch among a multiple TCI mode and a single TCI mode.

In some embodiments, the at least one DCI message is multiple DCI messages. The circuitry is further configured to: apply the first TCI state and the second TCI state at a first starting point associated with the first control resource set pool and a second starting point associated with the second control resource set pool, respectively.

In some embodiments, the circuitry is further configured to: receive a configuration message from the network, the configuration message, indicating: at least one first transmission occasion associated with the first TCI state, and at least one second transmission occasion associated with the second TCI state.

In some embodiments, the at least one second transmission occasion is linked to the at least one first transmission occasion by at least one pre-configuration parameter.

In some embodiments, the circuitry is further configured to: activate the at least one first transmission occasion and the at least one second transmission occasion based on at least one of the following: the at least one TCI state, or a switch among a multiple TCI mode and a single TCI mode.

In some embodiments, at least one transmission parameter associated with the at least one first transmission occasion is the same with at least second transmission parameter associated with the at least one second transmission occasion.

In some embodiments, the at least transmission parameter comprises at least one of the following: a transmission scheme, a repetition number, a beam mapping pattern, or a TCI mapping pattern.

In some embodiments, the at least one first transmission occasion and the at least one second transmission occasion are associated with at least one of the following: PDCCH, PDSCH, PUCCH, or PUSCH.

In some example embodiments, the terminal device 120 comprises circuitry configured to: receive at least one DCI message indicating at least one TCI state to be applied by the terminal device 120; and perform a PUSCH transmission by at least one of the following: performing the PUSCH transmission based on precoding information determined by a latest SRS transmission transmitted with the at least one indicated TCI states; or applying the at least one indicated TCI state to the PUSCH transmission if the latest SRS transmission is transmitted based on the at least one indicated TCI state.

In some embodiments, the circuitry is further configured to: after transmitting an acknowledgement for the at least one DCI message, delay to apply the at least one indicated TCI state to the PUSCH transmission until obtaining the precoding information corresponding to the at least one indicated TCI state.

In some embodiments, the circuitry is further configured to: delay to apply the at least one indicated TCI state by: performing a SRS transmission with a network by applying the at least one indicated TCI state; receiving, from the network, information for determining the precoding information corresponding to the at least one indicated TCI state; and applying the at least one indicated TCI state to the PUSCH transmission.

In some embodiments, the circuitry is further configured to: if the PUSCH transmission is a NCB PUSCH transmission, perform the SRS transmission by: receiving a RS from the network; determining candidate precoding information based on the RS; and performing the SRS transmission based on the candidate precoding information.

In some embodiments, if the at least one indicated TCI state comprises a first TCI state and a second TCI state, the circuitry is further configured to perform the PUSCH transmission by: performing a first PUSCH transmission based on first precoding information determined by a latest first SRS transmission transmitted with the indicated first TCI states; and performing a second PUSCH transmission based on second precoding information determined by a latest SRS transmission transmitted with the indicated second TCI states.

In some embodiments, if the at least one indicated TCI state comprises a first TCI state and a second TCI state, the circuitry is further configured to: perform the PUSCH transmission by: applying the indicated first TCI state to the PUSCH transmission if a latest first SRS transmission is transmitted based on the indicated first TCI state; and applying the indicated second TCI state to the PUSCH transmission if a latest second SRS transmission is transmitted based on the indicated second TCI state.

In some example embodiments, the terminal device 120 comprises circuitry configured to: detects a beam failure; and determine whether there is an available uplink TCI state; transmit a beam failure recovery request to a network with the available uplink TCI state in response to a determination that there is an available uplink TCI state.

In some embodiments, the circuitry is further configured to: if the beam failure is associated with a joint TCI state, disable an uplink transmission associated with the joint TCI state or transmit the uplink transmission associated with the joint TCI state with the available uplink TCI state.

In some embodiments, the circuitry is further configured to: transmit the uplink transmission associated with the joint TCI state with the available uplink TCI state by: in response to receiving a response of the beam failure recovery request from the network, starting to transmit the uplink transmission associated with the joint TCI state with the available uplink TCI state.

In some embodiments, the circuitry is further configured to: if the beam failure is associated with a joint TCI state, switch to a single TCI mode; and keep the single TCI mode until a multiple TCI mode switch condition meets.

In some embodiments, the terminal device 120 is configured with at least one TCI state used for uplink transmission and at least one TCI state used for downlink transmission, and a number of the TCI state used for uplink transmission is no less than a number of TCI state used for downlink transmission.

In some example embodiments, the network device 110 comprises circuitry configured to: transmit at least one DCI message, the at least one DCI message indicating at least one of the following: a first TCI indication associated with a first control resource set pool, a second TCI indication associated with a second control resource set pool, or a third TCI indication associated with either or both of the first and second control resource set pools; determine at least one TCI state based on the at least one DCI message, the at least one TCI state comprising at least one of the following: a first TCI state to be applied to the first control resource set pool, or a second TCI state to be applied to the second control resource set pool; and perform a transmission with a terminal device 120 based on the at least one TCI state.

In some embodiments, the circuitry is further configured to: perform a PUSCH transmission based on the at least one TCI state by at least one of the following: performing the PUSCH transmission based on precoding information determined by a latest SRS transmission transmitted with the at least one TCI states; performing a first PUSCH transmission based on first precoding information determined by a latest first SRS transmission transmitted with the indicated first TCI states; or performing a second PUSCH transmission based on second precoding information determined by a latest SRS transmission transmitted with the indicated second TCI states.

In some embodiments, the at least one DCI message is a single DCI message comprises: a first TCI field indicating the first TCI indication, and a second TCI field indicating the second TCI indication. The circuitry is further configured to: transmit a first MAC CE message indicating at least one first mapping and a second MAC CE message indicating at least one second mapping, where each first mapping indicating a first correspondence between a first TCI codepoint and a first TCI state configured for the first control resource set pool and each second mapping indicating a second correspondence between a second TCI codepoint and a second TCI state configured for the first control resource set pool.

In some embodiments, the circuitry is further configured to: transmit an indication indicating a presence of the second TCI field to the terminal device 120.

In some embodiments, the at least one DCI message is a single DCI message comprising a third TCI state field indicating the third TCI indication. The circuitry is further configured to: transmit a third MAC CE message indicating at least one third mapping, where each third mapping indicates a third correspondence between a third TCI codepoint and at least one third TCI state, the at least one third TCI state being configured for either or both of the first and second control resource set pools.

In some embodiments, a total bit size for indicating TCI information depends on at least one of the following: whether the at least one DCI messages is a single DCI or multiple DCI messages, a number of TCI fields comprised in at least one DCI messages, respective bit sizes of the TCI fields, or a number of TCI states indicated by the at least one DCI message.

In some embodiments, the circuitry is further configured to: perform the transmission with the terminal device 120 comprises performing at least one of the following: applying the first TCI state to a combination of physical channels associated with the first control resource set pool; or applying the second TCI state to a combination of physical channels associated with the second control resource set pool.

In some embodiments, the at least one DCI message is multiple DCI messages comprising: a first DCI message comprising a first TCI field indicating the first TCI indication, and a second DCI message comprising a second TCI field indicating the second TCI indication.

In some embodiments, if the at least one TCI state overlaps with at least one currently-applied TCI state, the circuitry is further configured to: perform the transmission with the terminal device 120 by: applying the overlapped TCI state prior to applying other TCI state of the at least one TCI state.

In some embodiments, the circuitry is further configured to: apply the overlapped TCI state prior to applying the other TCI state of the at least one TCI state by: applying the overlapped TCI state upon receiving an acknowledgement for the at least one DCI message from the terminal device 120; or applying the other TCI state upon after a certain period after receiving the acknowledgement for the at least one DCI message from the terminal device 120.

In some embodiments, the at least one DCI message is a single DCI message and is used to trigger a switch among a multiple TCI mode and a single TCI mode.

In some embodiments, the at least one DCI message is multiple DCI messages and the circuitry is further configured to: apply the overlapped TCI state by: applying the first TCI state and the second TCI state at a first starting point associated with the first control resource set pool and a second starting point associated with the second control resource set pool, respectively.

In some embodiments, the circuitry is further configured to: transmit a configuration message to the terminal device 120, where the configuration message, indicating: at least one first transmission occasion associated with the first TCI state, and at least one second transmission occasion associated with the second TCI state.

In some embodiments, the at least one second transmission occasion is linked to the at least one first transmission occasion by at least one pre-configuration parameter.

In some embodiments, the circuitry is further configured to: activate the at least one first transmission occasion and the at least one second transmission occasion based on at least one of the following: the at least one TCI state, or a switch among a multiple TCI mode and a single TCI mode.

In some embodiments, at least one transmission parameter associated with the at least one first transmission occasion is the same with at least second transmission parameter associated with the at least one second transmission occasion.

In some embodiments, the at least transmission parameter comprises at least one of the following: a transmission scheme, a repetition number, or a beam mapping pattern, or a TCI mapping pattern.

In some embodiments, the at least one first transmission occasion and the at least one second transmission occasion are associated with at least one of the following: PDCCH, PDSCH, PUCCH, or PUSCH.

In some example embodiments, the network device 110 comprises circuitry configured to: transmit at least one DCI message indicating at least one TCI state to be applied by a terminal device 120; and receive a PUSCH transmission by at least one of the following: receiving the PUSCH transmission based on precoding information determined by a latest SRS transmission transmitted with the at least one indicated TCI states; or applying the at least one indicated TCI state to the PUSCH transmission if the latest SRS transmission is transmitted based on the at least one indicated TCI state.

In some embodiments, the circuitry is further configured to: perform the PUSCH transmission by: after transmitting an acknowledgement for the at least one DCI message, delaying to apply the at least one indicated TCI state to the PUSCH transmission until obtaining the precoding information corresponding to the at least one indicated TCI state.

In some embodiments, the circuitry is further configured to: delay to apply the at least one indicated TCI state by: receiving a SRS transmission with a network by applying the at least one indicated TCI state; determining, the precoding information corresponding to the at least one TCI state based on the SRS transmission; and applying the at least one indicated TCI state to the PUSCH transmission.

In some embodiments, the circuitry is further configured to: if the PUSCH transmission is a NCB PUSCH transmission, receive the SRS transmission by: transmitting a RS to the terminal device 120; receiving the SRS transmission transmitted by the terminal device 120 based on candidate precoding information, the candidate precoding information being determined by the terminal device 120 based on the RS.

In some embodiments, the circuitry is further configured to: if the at least one indicated TCI state comprises a first TCI state and a second TCI state, perform the PUSCH transmission by: performing a first PUSCH transmission based on first precoding information determined by a latest first SRS transmission transmitted with the indicated first TCI states; and performing a second PUSCH transmission based on second precoding information determined by a latest SRS transmission transmitted with the indicated second TCI states.

In some embodiments, the circuitry is further configured to: if the at least one indicated TCI state comprises a first TCI state and a second TCI state, perform the PUSCH transmission by: applying the indicated first TCI state to the PUSCH transmission if a latest first SRS transmission is transmitted based on the indicated first TCI state; and applying the indicated second TCI state to the PUSCH transmission if a latest second SRS transmission is transmitted based on the indicated second TCI state.

In some example embodiments, the network device 110 comprises circuitry configured to: receive a beam failure recovery request transmitted by a terminal device 120 with the available uplink TCI state; and transmit a response of the beam failure recovery request to the terminal device 120.

In some embodiments, the circuitry is further configured to: if the beam failure is associated with a joint TCI state, disable an uplink transmission associated with the joint TCI state, or receive the uplink transmission associated with the joint TCI state with the available uplink TCI state.

In some embodiments, the circuitry is further configured to: receive the uplink transmission associated with the joint TCI state with the available uplink TCI state by: in response to transmitting a response of the beam failure recovery request from the network device 110, starting to receive the uplink transmission associated with the joint TCI state with the available uplink TCI state.

In some embodiments, the circuitry is further configured to: if the beam failure is associated with a joint TCI state, switch to a single TCI mode; and keep the single TCI mode until a multiple TCI mode switch condition meets.

In some embodiments, the terminal device 120 is configured with at least one TCI state used for uplink transmission and at least one TCI state used for downlink transmission, and a number of the TCI state used for uplink transmission is no less than a number of TCI state used for downlink transmission.

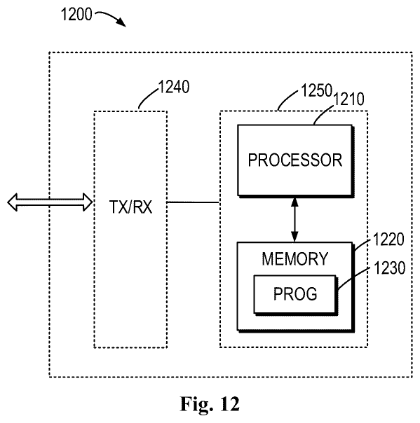

FIG. 12 is a simplified block diagram of a device 1200 that is suitable for implementing embodiments of the present disclosure. The device 1200 can be considered as a further example implementation of the terminal 120 and the network devices 110-1 and 110-2 as shown in FIGS. 1A to 1C. Accordingly, the device 1200 can be implemented at or as at least a part of the terminal 120 and the network devices 110-1 and 110-2.

As shown, the device 1200 includes a processor 1210, a memory 1220 coupled to the processor 1210, a suitable transmitter (TX) and receiver (RX) 1240 coupled to the processor 1210, and a communication interface coupled to the TX/RX 1240. The memory 1210 stores at least a part of a program 1230. The TX/RX 1240 is for bidirectional communications. The TX/RX 1240 has at least one antenna to facilitate communication, though in practice an Access Node mentioned in this application may have several ones. The communication interface may represent any interface that is necessary for communication with other network elements, such as X2 interface for bidirectional communications between eNBs, S1 interface for communication between a Mobility Management Entity (MME)/Serving Gateway (S-GW) and the eNB, Un interface for communication between the eNB and a relay node (RN), or Uu interface for communication between the eNB and a terminal device.

The program 1230 is assumed to include program instructions that, when executed by the associated processor 1210, enable the device 1200 to operate in accordance with the embodiments of the present disclosure, as discussed herein with reference to FIGS. 3-11. The embodiments herein may be implemented by computer software executable by the processor 1210 of the device 1200, or by hardware, or by a combination of software and hardware. The processor 1210 may be configured to implement various embodiments of the present disclosure. Furthermore, a combination of the processor 1210 and memory 1220 may form processing means 1250 adapted to implement various embodiments of the present disclosure.

The memory 1220 may be of any type suitable to the local technical network and may be implemented using any suitable data storage technology, such as a non-transitory computer readable storage medium, semiconductor-based memory devices, magnetic memory devices and systems, optical memory devices and systems, fixed memory and removable memory, as non-limiting examples. While only one memory 1220 is shown in the device 1200, there may be several physically distinct memory modules in the device 1200. The processor 1210 may be of any type suitable to the local technical network, and may include one or more of general purpose computers, special purpose computers, microprocessors, digital signal processors (DSPs) and processors based on multicore processor architecture, as non-limiting examples. The device 1200 may have multiple processors, such as an application specific integrated circuit chip that is slaved in time to a clock which synchronizes the main processor.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representation, it will be appreciated that the blocks, apparatus, systems, techniques or methods described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the process or method as described above with reference to FIGS. 3-11. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing apparatus, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

The above program code may be embodied on a machine readable medium, which may be any tangible medium that may contain, or store a program for use by or in connection with an instruction execution system, apparatus, or device. The machine readable medium may be a machine readable signal medium or a machine readable storage medium. A machine readable medium may include but not limited to an electronic, magnetic, optical, electromagnetic, infrared, or semiconductor system, apparatus, or device, or any suitable combination of the foregoing. More specific examples of the machine readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in language specific to structural features and/or methodological acts, it is to be understood that the present disclosure defined in the appended claims is not necessarily limited to the specific features or acts described above. Rather, the specific features and acts described above are disclosed as example forms of implementing the claims.

1-61. (canceled)

62. A method, performed by a terminal device, the method comprising:
receiving information indicating a first transmission configuration indicator (TCI) state and a second TCI state;
receiving a configuration message indicating both the first TCI state and the second TCI state to be applied for a physical uplink shared channel (PUSCH) transmission; and
performing, with a network device, the PUSCH transmission,
wherein:
the PUSCH transmission is associated with a first PUSCH transmission occasion and a second PUSCH transmission occasion,
the first TCI state is applied to the first PUSCH transmission occasion associated with a first sounding reference signal (SRS) resource identified by a first SRS resource indicator in downlink control information (DCI), and the second TCI state is applied to the second PUSCH transmission occasion associated with a second SRS resource identified by a second SRS resource indicator in the DCI.

63. The method of claim 62, wherein:
the first TCI state is applied to the first SRS resource, the second TCI state is applied to the second SRS resource.

64. The method of claim 62, wherein:
the first SRS resource corresponds to a most recent first transmission of SRS resource identified by the first SRS resource indicator, the second SRS resource corresponds to a most recent second transmission of SRS resource identified by the second SRS resource indicator.

65. The method of claim 62, wherein:
the PUSCH transmission is performed based on a first precoder, the first precoder is determined based on the first SRS resource indicator.

66. The method of claim 62, wherein:
the PUSCH transmission is performed based on a second precoder, the second precoder is determined based on the second SRS resource indicator.

67. The method of claim 62, the method comprising:
receiving a first mapping and a second mapping via media access control (MAC) control element (CE) signaling, the first mapping indicating a correspondence between the first TCI state and a TCI codepoint of a DCI message is associated with a first control resource set (CORESET) pool, and the second mapping indicating a correspondence between the second TCI state and the TCI codepoint of the DCI message is associated with a second CORESET pool.

68. The method of claim 62, wherein:
the PUSCH transmission is a non-codebook based transmission.

69. The method of claim 62, wherein:
the information comprises further DCI.

70. A method, performed by a network device, the method comprising:
transmitting information indicating a first transmission configuration indicator (TCI) state and a second TCI state;
transmitting a configuration message indicating both the first TCI state and the second TCI state to be applied for a physical uplink shared channel (PUSCH) transmission; and
performing, with a terminal device, the PUSCH transmission,
wherein:
the PUSCH transmission is associated with a first PUSCH transmission occasion and a second PUSCH transmission occasion,
the first TCI state is applied to the first PUSCH transmission occasion associated with a first sounding reference signal (SRS) resource identified by a first SRS resource indicator in downlink control information (DCI), and the second TCI state is applied to the second PUSCH transmission occasion associated with a second SRS resource identified by a second SRS resource indicator in the DCI.

71. The method of claim 70, wherein:
the first TCI state is applied to the first SRS resource, the second TCI state is applied to the second SRS resource.

72. The method of claim 70, wherein:
the first SRS resource corresponds to a most recent first transmission of SRS resource identified by the first SRS resource indicator, the second SRS resource corresponds to a most recent second transmission of SRS resource identified by the second SRS resource indicator.

73. The method of claim 70, wherein:
the PUSCH transmission is performed based on a first precoder, the first precoder is determined based on the first SRS resource indicator.

74. The method of claim 70, wherein:
the PUSCH transmission is performed based on a second precoder, the second precoder is determined based on the second SRS resource indicator.

75. The method of claim 70, the method comprising:
receiving a first mapping and a second mapping via media access control (MAC) control element (CE) signaling, the first mapping indicating a correspondence between the first TCI state and a TCI codepoint of a DCI message is associated with a first control resource set (CORESET) pool, and the second mapping indicating a correspondence between the second TCI state and the TCI codepoint of the DCI message is associated with a second CORESET pool.

76. The method of claim 70, wherein:
the PUSCH transmission is a non-codebook based transmission.

77. The method of claim 70, wherein:
the information comprises further DCI.

78. A terminal device, comprising a processor configured to cause the terminal device to:
receive information indicating a first transmission configuration indicator (TCI) state and a second TCI state;
receive a configuration message indicating both the first TCI state and the second TCI state to be applied for a physical uplink shared channel (PUSCH) transmission; and
perform, with a network device, the PUSCH transmission,
wherein:
the PUSCH transmission is associated with a first PUSCH transmission occasion and a second PUSCH transmission occasion,
the first TCI state is applied to the first PUSCH transmission occasion associated with a first sounding reference signal (SRS) resource identified by a first SRS resource indicator in downlink control information (DCI), and the second TCI state is applied to the second PUSCH transmission occasion associated with a second SRS resource identified by a second SRS resource indicator in the DCI.

79. The terminal device of claim 78, wherein:
the first TCI state is applied to the first SRS resource, the second TCI state is applied to the second SRS resource.

80. A network device, comprising a processor configured to cause the network device to:
transmit information indicating a first transmission configuration indicator (TCI) state and a second TCI state;
transmit a configuration message indicating both the first TCI state and the second TCI state to be applied for a physical uplink shared channel (PUSCH) transmission; and
perform, with a terminal device, the PUSCH transmission,
wherein:
the PUSCH transmission is associated with a first PUSCH transmission occasion and a second PUSCH transmission occasion,
the first TCI state is applied to the first PUSCH transmission occasion associated with a first sounding reference signal (SRS) resource identified by a first SRS resource indicator in downlink control information (DCI), and the second TCI state is applied to the second PUSCH transmission occasion associated with a second SRS resource identified by a second SRS resource indicator in the DCI.

81. The network device of claim 80, wherein:
the first TCI state is applied to the first SRS resource, the second TCI state is applied to the second SRS resource.
